(19) United States
(12) Patent Application Publication
(10) Pub. No.: US 2026/0032496 A1
(43) Pub. Date: Jan. 29, 2026

(54) METHOD AND APPARATUS FOR AIML ASSISTED MOBILITY IN A WIRELESS COMMUNICATION SYSTEM

(71) Applicant: ASUS Technology Licensing Inc., Taipei City (TW)

(72) Inventors: Cheng-Hsiu Chen, Taipei City (TW); Meng-Hui Ou, Taipei City (TW); Yu-Hsuan Guo, Taipei City (TW)

(21) Appl. No.: 19/277,256

(22) Filed: Jul. 22, 2025

Related U.S. Application Data
(60) Provisional application No. 63/674,775, filed on Jul. 23, 2024.
(60) Provisional application No. 63/674,782, filed on Jul. 23, 2024.

(51) Int. Cl. H04W 24/10; H04B 17/373; H04L 41/16

(52) U.S. Cl. CPC H04W 24/10; H04B 17/373; H04L 41/16

(57) ABSTRACT

Methods, systems, and apparatuses are provided for Artificial Intelligence/Machine Learning (AI/ML) assisted mobility in a wireless communication system, wherein a method for a User Equipment (UE) comprises receiving a first configuration of an AI/ML functionality for a measurement prediction, and performing at least one action based on at least an evaluation of quality of a cell from the measurement prediction, wherein the at least one action includes reporting an outcome of the evaluation to a network.

### CROSS-REFERENCE TO RELATED APPLICATIONS

The present application claims priority to and the benefit of U.S. Provisional Patent Application Ser. No. 63/674,775, filed Jul. 23, 2024, and U.S. Provisional Patent Application Ser. No. 63/674,782, filed Jul. 23, 2024; with each of the referenced and identified applications and disclosures hereby fully incorporated herein by reference.

### FIELD

This disclosure generally relates to wireless communication networks and, more particularly, to a method and apparatus for Artificial Intelligence/Machine Learning (AI/ML or AIML) assisted mobility in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for Artificial Intelligence/Machine Learning (AI/ML or AIML) assisted mobility in a wireless communication system. The AI/ML functionality can be utilized in the User Equipment (UE) and measurements may function well when problems related to AI/ML functionality occur.

In various embodiments, a method for a UE in a wireless communication system comprises receiving a first configuration of an AI/ML functionality for a measurement prediction, and performing at least one action based on at least an evaluation of quality of a cell from the measurement prediction, wherein the at least one action includes reporting an outcome of the evaluation to a network.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 5.5.5.1-1: Measurement reporting, from 3GPP TS 38.331 V18.1.0 (2024-03).

FIG. 6 is a first example diagram showing a first procedure used to indicate applicable functionalities of a UE to a NW, in accordance with embodiments of the present invention.

FIG. 7 is a second example diagram showing a first procedure used to indicate applicable functionalities of a UE to a NW, in accordance with embodiments of the present invention.

FIG. 8 is a first example diagram showing a second procedure used to perform functionality/model selection, activation, deactivation, switching, and/or fallback operation of an AI/ML functionality and perform measurement related actions on a UE, in accordance with embodiments of the present invention.

FIG. 9 is a second example diagram showing a second procedure used to perform functionality/model selection, activation, deactivation, switching, and/or fallback operation of an AI/ML functionality and perform measurement related actions on a UE, in accordance with embodiments of the present invention.

FIG. 10 is an example diagram showing how failure impacts the network performance and may lead to disconnections, and further wasting the UE's limited power, in accordance with embodiments of the present invention.

FIG. 11 is an example diagram showing that based on an event configured by a network, wherein the conditions for the event includes at least the quality of at least one cell from the measurement prediction, the UE reports the outcome (e.g., measurement result) of the event to the network; and the UE performs at least one action, in accordance with embodiments of the present invention.

FIG. 12 is a flow diagram of a method for a first UE in a wireless communication system comprising receiving a first RRC message, from a network, transmitting a second RRC message, to a network, transmitting a third RRC message, to a network, receiving a fourth RRC message, from a network, transmitting a fifth RRC message, to a network, transmitting a sixth RRC message, to a network, and receiving a seventh signaling, from a network, in accordance with embodiments of the present invention.

FIG. 13 is an example diagram showing that a UE may not switch to a (legacy) measurement (e.g., measurement without AI/ML functionality) immediately after some problem occurs and the UE stops performing AI/ML functionality, e.g., if (at least) the UE has previously predicted measurements for future and/or current time instances, in accordance with embodiments of the present invention.

FIG. 14 is an example diagram showing that a UE may switch to a (legacy) measurement (e.g., measurement without AI/ML functionality) immediately after some problem occurs and/or the UE stops performing AI/ML functionality, in accordance with embodiments of the present invention.

FIG. 15 is an example diagram showing another example of report and switching timing, in accordance with embodiments of the present invention.

FIG. 16 is a flow diagram of a method for UE in a wireless communication system comprising switching from a first method to a second method/configuration, transmitting a message, to a network, and receiving a message, from a network, in accordance with embodiments of the present invention.

FIG. 17 is a flow diagram of a method for UE in a wireless communication system comprising transmitting a message, to a network, receiving a message, from a network, and switching from a first method to a second method/configuration, in accordance with embodiments of the present invention.

FIG. 18 is a flow diagram of a method for UE in a wireless communication system comprising receiving a first configuration of an AI/ML functionality for a measurement prediction, and performing at least one action based on at least an evaluation of quality of a cell from the measurement prediction, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WIMAX®, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-240082, “Revised SID on AIML for mobility in NR”; [2]3GPP TR 38.843 V18.0.0 (2023-12) 3GPP; TSG RAN; Study on Artificial Intelligence (AI)/Machine Learning (ML) for NR air interface (Release 18); [3]3GPP TS 38.331 V18.1.0 (2024-03) 3GPP; TSG RAN; NR; Radio Resource Control (RRC) protocol specification (Release 18); and [4] Email discussion “[POST126][032][AI/ML PHY] LCM (Intel/Samsung)”. The standards and documents listed above are hereby expressly and fully incorporated herein by reference in their entirety.

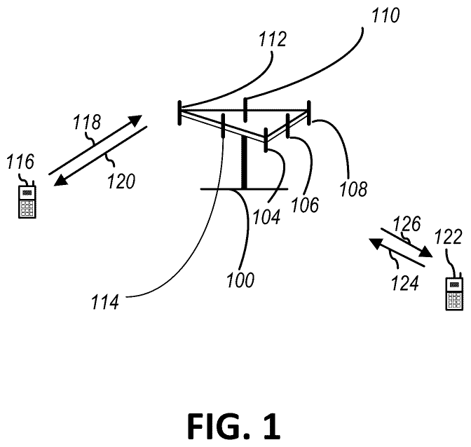

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

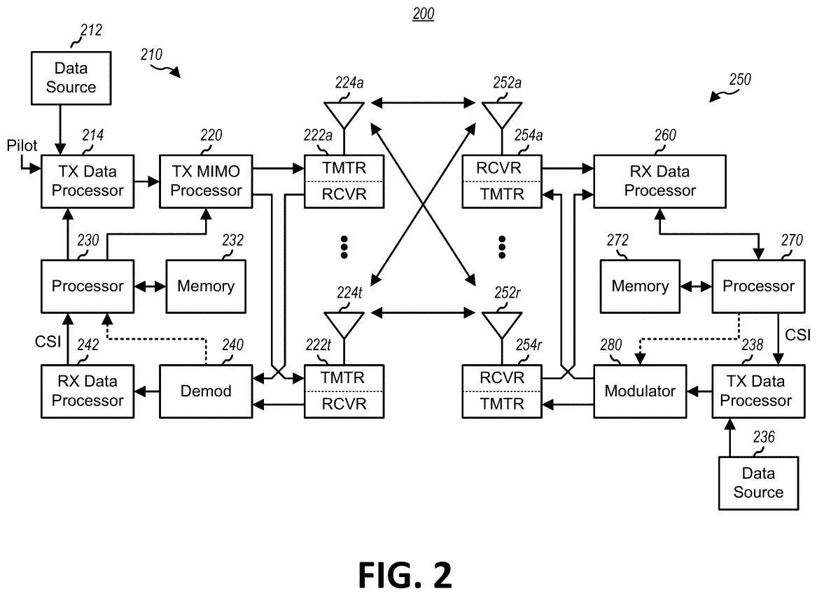

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

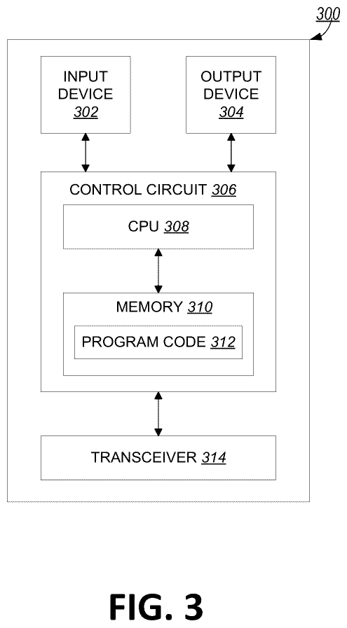

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

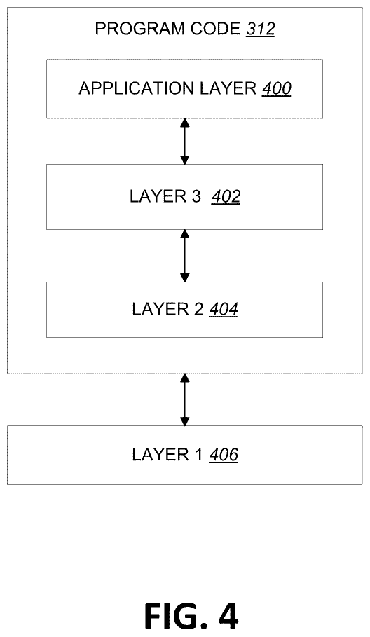

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

In [1] SID RP-240082, the objectives of AI/ML Mobility are specified:

### Start of Quotation [1]

### 3 Justification

With existing L3 handover mechanism, handover is triggered and executed based on reported historical measurement result and/or measurement event(s) i.e., it is kind of reactive scheme by its nature. It may work well among macro cells when UE's mobility is low for existing services. But it could be problematic when either UE's mobility is high or among micro cells of high density or both for existing services or future services e.g. XR, where such reactive scheme may result in more unintended event e.g., handover failure, radio link failure, Ping-Pong phenomenon, throughput loss or too early/late handover etc. To improve handover robustness conditional handover is introduced in Rel-16. And to reduce interruption time of frequent handover among small cells LTM HO is introduced in Rel-18. However, these two mechanisms are not sufficient because they are still reactive scheme by design. On the other hand, mechanism based on AI/ML algorithm has the potential to enable proactive scheme.

In Rel-18 SID called FS_NR_AIML_air was studied extensively on physical layer centric use cases including spatial and temporal beam prediction. Temporal prediction within serving cell is mainly to predict the best or top-K beam(s) or beam pair(s) in time domain in order to improve UE throughput. While predict the best or top-K beam(s) or beam pair(s) among a set of beams by measuring a smaller set of beams could help reduce RS signalling overhead, measurement efforts and UE power consumption etc. By extended L1 beam measurement from serving cell to neighbouring cell, majority of the RAN1 work can be reused. Since L3 measurement is based on filtering of L1 measurement, the study of AI/ML for air can be leveraged for mobility purpose e.g., temporal prediction can also be used to predict beam(s)/cell(s) becoming worse so that unintended event like radio link failure or short-stay handover can be avoided.

Mobility enhancement was also studied in RAN3 in Rel-17 in SID called FS_NR_ENDC_data_collect and is now specified in Rel-18 WID NR_AIML_NGRAN-Core. In these RAN3 items the study and normative work on mobility enhancement is based on information available in network side e.g. handover and stay of time in history among cells to predict UE's trajectory in single hop and hence potential candidates. In Rel-19 RAN3 will further work on UE's trajectory for multiple hops. The predicted UE's trajectory could be helpful for study on AI/ML mobility over air interface to some extent.

Based on progress made in RAN1 and RAN3 so far and assumption on UE's trajectory it is feasible to predict RRM measurement and/or event and hence candidate target cell in UE side. In network side new assistant information, if necessary, and statistics information based on measurement report from UE and/or neighbouring nodes can be also used for smart prediction. If some prediction information could be known by network, handover and/or RRM performance can be improved by proactive measures to either make a better decision or avoid unintended event.

### 4 Objective

### 4.1 Objective of SI or Core Part WI or Testing Part WI

The study will focus on mobility enhancement in RRC_CONNECTED mode over air interface by following existing mobility framework, i.e., handover decision is always made in network side. Mobility use cases focus on standalone NR PCell change. UE-side and network-side AI/ML model can be both considered, respectively.

Study and evaluate potential benefits and gains of AI/ML aided mobility for network triggered L3-based handover, considering the following aspects:
AI/ML based RRM measurement and event prediction,
   Cell-level measurement prediction including intra and inter-frequency (UE sided and NW sided model) [RAN2]
      Inter-cell Beam-level measurement prediction for L3 Mobility (UE sided and NW sided model) [RAN2]
   HO failure/RLF prediction (UE sided model) [RAN2]
   Measurement events prediction (UE sided model) [RAN2]
Study the need/benefits of any other UE assistance information for the network side model [RAN2]
The evaluation of the AI/ML aided mobility benefits should consider HO performance KPIs (e.g., Ping-pong HO, HOF/RLF, Time of stay, Handover interruption, prediction accuracy, and measurement reduction) etc.) and complexity tradeoffs [RAN2]
   NOTE: Simulation assumption and methodology can leverage TR 38.901, 38.843 and 36.839. And leave the detail discussion to RAN2
Potential AI mobility specific enhancement should be based on the Rel19 AI/ML-air interface WID general framework (e.g. LCM, performance monitoring etc) [RAN2]
   NOTE: This would only be treated after sufficient progress is made in the Rel-19 AI/ML air interface WID
Potential specification impacts of AI/ML aided mobility [RAN2]
Evaluate testability, interoperability, and impacts on RRM requirements and performance [RAN4]

### End of Quotation [1]

In TR 38.843 ([2]3GPP TR 38.843 V18.0.0 (2023-12) 3GPP), a general framework and operations for LCM are studied:

### Start of Quotation [2]

### 4 General AI/ML Framework

The purpose of this clause is to identify common notation and terminology for AI/ML related functions, procedures and interfaces.

### 4.1 Description of AI/ML Stages

In this clause, the defining stages of AI/NL related algorithms and associated complexity are characterized, namely:
Model generation, e.g., model training (including input/output, pre-/post-process, online/offline as applicable), model validation, model testing, as applicable
Inference operation, e.g., input/output, pre-/post-process, as applicable

In addition, the treatment of dataset(s) for training, validation, testing, and inference is documented.

### 4.2 Life Cycle Management

In this clause, the life cycle management (LCM) of AI/ML model (e.g., model training, model deployment, model inference, model monitoring, model updating) and AI/ML functionality are characterized.

The following aspects, including the definition of components (if needed) and necessity, are studied in LCM:
Data collection
   Note: This also includes associated assistance information, if applicable.
Model training
Functionality/model identification
Model delivery/transfer
Model inference operation
Functionality/model selection, activation, deactivation, switching, and fallback operation.
   Including: Decision by the network (either network initiated or UE-initiated and requested to the network), decision by the UE (event-triggered as configured by the network, UE's decision reported to the network, or UE-autonomous either with UE's decision reported to the network or without it)
Functionality/model monitoring
Model update
   UE capability

### 4.2.1 LCM Flavours

The LCM procedure is studied for the case that an AI/ML model has a model ID with associated information and/or for the case that a given functionality is provided by some AI/ML operations. Note: Applicability of functionality-based LCM and model-ID-based LCM is a separate discussion.

From RAN1 perspective, an AI/ML model identified by a model ID may be logical, and how it maps to physical AI/ML model(s) may be up to implementation. When distinction is necessary for discussion purposes, companies may use the term a logical AI/ML model to refer to a model that is identified and assigned a model ID, and physical AI/ML model(s) to refer to an actual implementation of such a model.

For UE-side models and UE-part of two-sided models:
For AI/ML functionality identification
   Legacy 3GPP framework of feature is taken as a starting point.
   UE indicates supported functionalities/functionality for a given sub-use-case.
      UE capability reporting is taken as starting point.
For AI/ML model identification
   Models are identified by model ID at the Network. UE indicates supported AI/ML models.

In functionality-based LCM, network indicates activation/deactivation/fallback/switching of AI/ML functionality via 3GPP signalling (e.g., RRC, MAC-CE, DCI). Models may not be identified at the Network, and UE may perform model-level LCM. Whether and how much awareness/interaction NW should have about model-level LCM requires further study. For functionality identification, there may be either one or more than one Functionalities defined within an AT/ML-enabled feature, whereby AT/ML-enabled Feature refers to a Feature where AI/ML may be used. Note: UE may have one AI/ML model for the functionality, or UE may have multiple AI/ML models for the functionality.

For AI/ML functionality identification and functionality-based LCM of UE-side models and/or UE-part of two-sided models, functionality refers to an AT/ML-enabled Feature/FG enabled by configuration(s), where configuration(s) is(are) supported based on conditions indicated by UE capability. Correspondingly, functionality-based LCM operates based on, at least, one configuration of AI/ML-enabled Feature/FG or specific configurations of an AI/ML-enabled Feature/FG.

After functionality identification, necessity, mechanisms, for UE to report updates on applicable functionality(es) among functionality(es) are studied, where the applicable functionalities may be a subset of all functionalities. Applicable functionalities can be reported by the UE.

In model-ID-based LCM, models are identified at the Network, and Network/UE may activate/deactivate/select/switch individual AI/ML models via model ID.

For AI/ML model identification and model-ID-based LCM of UE-side models and/or UE-part of two-sided models, model-ID-based LCM operates based on identified models, where a model may be associated with specific configurations/conditions associated with UE capability of an AT/ML-enabled Feature/FG and additional conditions (e.g., scenarios, sites, and datasets) as determined/identified between UE-side and NW-side.

After model identification, necessity, mechanisms, for UE to report updates on applicable UE part/UE-side model(s), are studied, where the applicable models may be a subset of all identified models. Applicable models can be reported by the UE.

How to handle the impact of UE's internal conditions such as memory, battery, and other hardware limitations on functionality/model operations and AT/ML-enabled Feature is to be studied. Note: it does not preclude any existing solutions.

For functionality/model-ID based LCM, once functionalities/models are identified, the same or similar procedures may be used for their activation, deactivation, switching, fallback, and monitoring.

Model ID, if needed, can be used in a Functionality (defined in functionality-based LCM) for LCM operations.

### End of Quotation [2]

In TS 38.331 ([3]3GPP TS 38.331 V18.1.0 (2024-03) 3GPP), the procedure for measurement is specified:

### Start of Quotation [3]

### 5.5 Measurements

### 5.5.1 Introduction

The network may configure an RRC_CONNECTED UE to perform measurements. The network may configure the UE to report them in accordance with the measurement configuration or perform conditional reconfiguration evaluation in accordance with the conditional reconfiguration. The measurement configuration is provided by means of dedicated signalling i.e. using the RRCReconfiguration or RRCResume.

The network may configure the UE to perform the following types of measurements:
NR measurements;
Inter-RAT measurements of E-UTRA frequencies;
Inter-RAT measurements of UTRA-FDD frequencies;
NR sidelink measurements of L2 U2N Relay UEs.

The network may configure the UE to report the following measurement information based on SS/PBCH block(s):
Measurement results per SS/PBCH block;
Measurement results per cell based on SS/PBCH block(s);
SS/PBCH block(s) indexes.

The network may configure the UE to report the following measurement information based on CSI-RS resources:
Measurement results per CSI-RS resource;
Measurement results per cell based on CSI-RS resource(s);
CSI-RS resource measurement identifiers.

The measurement configuration includes the following parameters:
1. Measurement objects: A list of objects on which the UE shall perform the measurements.
   For intra-frequency and inter-frequency measurements a measurement object indicates the frequency/time location and subcarrier spacing of reference signals to be measured. Associated with this measurement object, the network may configure a list of cell specific offsets, a list of ‘exclude-listed’ cells and a list of ‘allow-listed’ cells. Exclude-listed cells are not applicable in event evaluation or measurement reporting. Allow-listed cells are the only ones applicable in event evaluation or measurement reporting.
   The measObjectId of the MO which corresponds to each serving cell is indicated by servingCellMO within the serving cell configuration.
   For inter-RAT E-UTRA measurements a measurement object is a single E-UTRA carrier frequency. Associated with this E-UTRA carrier frequency, the network can configure a list of cell specific offsets and a list of ‘exclude-listed’ cells. Exclude-listed cells are not applicable in event evaluation or measurement reporting.
   For inter-RAT UTRA-FDD measurements a measurement object is a set of cells on a single UTRA-FDD carrier frequency.
2. Reporting configurations: A list of reporting configurations where there can be one or multiple reporting configurations per measurement object. Each measurement reporting configuration consists of the following:
   Reporting criterion: The criterion that triggers the UE to send a measurement report. This can either be periodical or a single event description.
   RS type: The RS that the UE uses for beam and cell measurement results (SS/PBCH block or CSI-RS).
   Reporting format: The quantities per cell and per beam that the UE includes in the measurement report (e.g. RSRP) and other associated information such as the maximum number of cells and the maximum number beams per cell to report.

In case of conditional reconfiguration, each configuration consists of the following:
Execution criteria: The criteria the UE uses for conditional reconfiguration execution.
RS type: The RS that the UE uses for obtaining beam and cell measurement results (SS/PBCH block-based or CSI-RS-based), used for evaluating conditional reconfiguration execution condition.
3. Measurement identities: For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.
4. Quantity configurations: The quantity configuration defines the measurement filtering configuration used for all event evaluation and related reporting, and for periodical reporting of that measurement. For NR measurements, the network may configure up to 2 quantity configurations with a reference in the NR measurement object to the configuration that is to be used. In each configuration, different filter coefficients can be configured for different measurement quantities, for different RS types, and for measurements per cell and per beam.
5. Measurement gaps: Periods that the UE may use to perform measurements.
6. Effective measurement window: Periods that the UE may use to perform inter RAT measurements.

A UE in RRC_CONNECTED maintains a measurement object list, a reporting configuration list, and a measurement identities list according to signalling and procedures in this specification. The measurement object list possibly includes NR measurement object(s), CLI measurement object(s), inter-RAT objects, and L2 U2N Relay objects. Similarly, the reporting configuration list includes NR, inter-RAT, and L2 U2N Relay reporting configurations. Any measurement object can be linked to any reporting configuration of the same RAT type. Some reporting configurations may not be linked to a measurement object. Likewise, some measurement objects may not be linked to a reporting configuration.

The measurement procedures distinguish the following types of cells:
1. The NR serving cell(s)—these are the SpCell and one or more SCells.
2. Listed cells—these are cells listed within the measurement object(s).
3. Detected cells—these are cells that are not listed within the measurement object(s) but are detected by the UE on the SSB frequency(ies) and subcarrier spacing(s) indicated by the measurement object(s).

For NR measurement object(s), the UE measures and reports on the serving cell(s)/serving Relay UE (for L2 U2N Remote UE), listed cells and/or detected cells. For inter-RAT measurements object(s) of E-UTRA, the UE measures and reports on listed cells and detected cells and, for RSSI and channel occupancy measurements, the UE measures and reports on the configured resources on the indicated frequency. For inter-RAT measurements object(s) of UTRA-FDD, the UE measures and reports on listed cells. For CLI measurement object(s), the UE measures and reports on configured measurement resources (i.e. SRS resources and/or CLI-RSSI resources). For L2 U2N Relay object(s), the UE measures and reports on the serving NR cell(s), as well as the discovered L2 U2N Relay UEs.

Whenever the procedural specification, other than contained in clause 5.5.2, refers to a field it concerns a field included in the VarMeasConfig unless explicitly stated otherwise i.e. only the measurement configuration procedure covers the direct UE action related to the received measConfig.

In NR-DC, the UE may receive two independent measConfig:
a measConfig, associated with MCG, that is included in the RRCReconfiguration message received via SRB1; and
a measConfig, associated with SCG, that is included in the RRCReconfiguration message received via SRB3, or, alternatively, included within a RRCReconfiguration message embedded in a RRCReconfiguration message received via SRB1.

In this case, the UE maintains two independent VarMeasConfig and VarMeasReportList, one associated with each measConfig, and independently performs all the procedures in clause 5.5 for each measConfig and the associated VarMeasConfig and VarMeasReportList, unless explicitly stated otherwise.

### 5.5.3 Performing Measurements

### 5.5.3.1 General

An RRC_CONNECTED UE shall derive cell measurement results by measuring one or multiple beams associated per cell as configured by the network, as described in 5.5.3.3. For all cell measurement results, except for RSSI, and CLI measurement results in RRC_CONNECTED, the UE applies the layer 3 filtering as specified in 5.5.3.2, before using the measured results for evaluation of reporting criteria, measurement reporting or the criteria to trigger conditional reconfiguration execution. For cell measurements, the network can configure RSRP, RSRQ, SINR, RSCP or EcN0 as trigger quantity. For CLI measurements, the network can configure SRS-RSRP or CLI-RSSI as trigger quantity. For cell and beam measurements, reporting quantities can be any combination of quantities (i.e. only RSRP; only RSRQ; only SINR; RSRP and RSRQ; RSRP and SINR; RSRQ and SINR; RSRP, RSRQ and SINR; only RSCP; only EcN0; RSCP and EcN0), irrespective of the trigger quantity, and for CLI measurements, reporting quantities can be either SRS-RSRP or CLI-RSSI. For conditional reconfiguration execution, the network can configure up to 2 quantities, both using same RS type. The UE does not apply the layer 3 filtering as specified in 5.5.3.2 to derive the CBR measurements. The UE does not apply the layer 3 filtering as specified in 5.5.3.2 to derive the Rx-Tx time difference measurements. The UE does not apply the layer 3 filtering as specified in 5.5.3.2 to derive the altitude measurements.

The network may also configure the UE to report measurement information per beam (which can either be measurement results per beam with respective beam identifier(s) or only beam identifier(s)), derived as described in 5.5.3.3a. If beam measurement information is configured to be included in measurement reports, the UE applies the layer 3 beam filtering as specified in 5.5.3.2. On the other hand, the exact L1 filtering of beam measurements used to derive cell measurement results is implementation dependent.

The UE shall:
1> whenever the UE has a measConfig, perform RSRP and RSRQ measurements for each serving cell for which servingCellMO is configured as follows:
   2> if the reportConfig associated with at least one measId included in the measIdList within VarMeasConfig contains an rsType set to ssb and ssb-ConfigMobility is configured in the measObject indicated by the servingCellMO:
      3> if the reportConfig associated with at least one measId included in the measIdList within VarMeasConfig contains a reportQuantityRS-Indexes and maxNrofRS-IndexesToReport and contains an rsType set to ssb:
         4> derive layer 3 filtered RSRP and RSRQ per beam for the serving cell based on SS/PBCH block, as described in 5.5.3.3a;
      3> derive serving cell measurement results based on SS/PBCH block, as described in 5.5.3.3;
   2> if the reportConfig associated with at least one measId included in the measIdList within VarMeasConfig contains an rsType set to csi-rs and CSI-RS-ResourceConfigMobility is configured in the measObject indicated by the servingCellMO:
      3> if the reportConfig associated with at least one measId included in the measIdList within VarMeasConfig contains a reportQuantityRS-Indexes and maxNro)RS-IndexesToReport and contains an rsType set to csi-rs:
         4> derive layer 3 filtered RSRP and RSRQ per beam for the serving cell based on CSI-RS, as described in 5.5.3.3a;
      3> derive serving cell measurement results based on CSI-RS, as described in 5.5.3.3;
1> for each serving cell for which servingCellMO is configured, if the reportConfig associated with at least one measId included in the measIdList within VarMeasConfig contains SINR as trigger quantity and/or reporting quantity:
   2> if the reportConfig contains rsType set to ssb and ssb-ConfigMobility is configured in the servingCellMO:
      3> if the reportConfigcontains a reportQuantityRS-Indexes and maxNro)RS-IndexesToReport:
         4> derive layer 3 filtered SINR per beam for the serving cell based on SS/PBCH block, as described in 5.5.3.3a;
      3> derive serving cell SINR based on SS/PBCH block, as described in 5.5.3.3;
   2> if the reportConfig contains rsType set to csi-rs and CSI-RS-ResourceConfigMobility is configured in the servingCellMO:
      3> if the reportConfigcontains a reportQuantityRS-Indexes and maxNrofRS-IndexesToReport:
         4> derive layer 3 filtered SINR per beam for the serving cell based on CSI-RS, as described in 5.5.3.3a;
      3> derive serving cell SINR based on CSI-RS, as described in 5.5.3.3;
1> for each measId included in the measIdList within VarMeasConfig:
   . . .
   2> if the reportType for the associated reportConfig is periodical, eventTriggered; or
   2> if the reportType for the associated reportConfig is condTriggerConfig, the measId is within the MCG VarMeasConfig and is indicated in the condExecutionCond or in the condExecutionCondPSCell associated to a condReconfigId in the MCG VarConditionalReconfig (for CHO, CPA, MN-initiated inter-SN CPC, or subsequent CPAC in NR-DC); or
   2> if the reportType for the associated reportConfig is condTriggerConfig, the measId is within the SCG VarMeasConfig and is indicated in the condExecutionCond associated to a condReconfigId in the SCG VarConditionalReconfig (for intra-SN CPC or subsequent CPAC); or
   2> if the reportType for the associated reportConfig is condTriggerConfig, the measId is within the SCG VarMeasConfig and is indicated in the condExecutionCondSCG associated to a condReconfigId in the MCG VarConditionalReconfig (for SN-initiated inter-SN CPC or subsequent CPAC in NR-DC); or
   2> if the reportType for the associated reportConfig is condTriggerConfig, the measId is within the SCG VarMeasConfig and is indicated in the triggerConditionSN associated to a condReconfigurationId in VarConditionalReconfiguration as specified in TS 36.331 [10](for SN-initiated inter-SN CPC in EN-DC):
      3> if a measurement gap configuration is setup, or
      3> if the UE does not require measurement gaps to perform the concerned measurements:
         4> if s-MeasureConfig is not configured, or
         4> if s-MeasureConfig is set to ssb-RSRP and the NR SpCell RSRP based on SS/PBCH block, after layer 3 filtering, is lower than ssb-RSRP, or
         4> if s-MeasureConfig is set to csi-RSRP and the NR SpCell RSRP based on CSI-RS, after layer 3 filtering, is lower than csi-RSRP:
         5> if the measObject is associated to NR and the rsType is set to csi-rs:
         6> if reportQuantityRS-Indexes and maxNrofRS-IndexesToReport for the associated reportConfig are configured:
         7> derive layer 3 filtered beam measurements only based on CSI-RS for each measurement quantity indicated in reportQuantityRS-Indexes, as described in 5.5.3.3a;
         6> derive cell measurement results based on CSI-RS for the trigger quantity and each measurement quantity indicated in reportQuantityCell using parameters from the associated measObject, as described in 5.5.3.3;
         5> if the measObject is associated to NR and the rsType is set to ssb:
         6> if reportQuantityRS-Indexes and maxNrofRS-IndexesToReport for the associated reportConfig are configured:
         7> derive layer 3 beam measurements only based on SS/PBCH block for each measurement quantity indicated in reportQuantityRS-Indexes, as described in 5.5.3.3a;
         6> derive cell measurement results based on SS/PBCH block for the trigger quantity and each measurement quantity indicated in reportQuantityCell using parameters from the associated measObject, as described in 5.5.3.3;
         . . .
         4> if the measRSSI-ReportConfig is configured in the associated reportConfig:
         5> perform the RSSI and channel occupancy measurements on the frequency configured by rmtc-Frequency in the associated measObject;
. . .

### 5.5.3.2 Layer 3 Filtering

The UE shall:
1> for each cell measurement quantity, each beam measurement quantity, each sidelink measurement quantity as needed in clause 5.8.10, for each CLI measurement quantity that the UE performs measurements according to 5.5.3.1, for each candidate L2 U2N Relay UE measurement quantity according to 5.5.3.4, for evaluating the detected NR sidelink U2N Relay UEs according to 5.8.15.3, for evaluating the SyncRef UE according to 5.8.5 and 5.8.6, for evaluating the NR sidelink U2U Relay/Remote UE threshold conditions according to 5.8.16.2 and 5.8.17.2, for evaluating the conditions for selection and reselection of NR sidelink U2U Relay UE according to 5.8.17.3, and for evaluating the detected NR sidelink U2U Relay UEs according to 5.8.17.4:
   2> filter the measured result, before using for evaluation of reporting criteria, for measurement reporting, for U2N/U2U Relay (re)selection evaluation or for evaluating the SyncRef UE, by the following formula:

$${F}_{n} = ( 1 - a ) * {F}_{n - 1} + a * {M}_{n}$$

where
   Mₙ is the latest received measurement result from the physical layer;
   Fₙ is the updated filtered measurement result, that is used for evaluation of reporting criteria, for measurement reporting, for U2N/U2U Relay (re)selection evaluation or for evaluating the SyncRef UE;
   Fₙ₋₁ is the old filtered measurement result, where F₀ is set to M₁ when the first measurement result from the physical layer is received; and for MeasObjectNR, a=½^{(ki/4)}, where kᵢ is the filterCoefficient for the corresponding measurement quantity of the i:th QuantityConfigNR in quantityConfigNR-List, and i is indicated by quantityConfigIndex in MeasObjectNR; for other measurements, a=½^{(k/4)}, where k is the filterCoefficient for the corresponding measurement quantity received by the quantityConfig; for UTRA-FDD, a=½^{(k/4)}, where k is the filterCoefficient for the corresponding measurement quantity received by quantityConfigUTRA-FDD in the QuantityConfig;
2> adapt the filter such that the time characteristics of the filter are preserved at different input rates, observing that the filterCoefficient k assumes a sample rate equal to X ms; The value of X is equivalent to one intra-frequency L1 measurement period as defined in TS 38.133 [14] assuming non-DRX operation, and depends on frequency range.
NOTE 1: If k is set to 0, no layer 3 filtering is applicable.
NOTE 2: The filtering is performed in the same domain as used for evaluation of reporting criteria, for measurement reporting, for U2N Relay (re)selection evaluation or for evaluating the SyncRef UE, i.e., logarithmic filtering for logarithmic measurements.
NOTE 3: The filter input rate is implementation dependent, to fulfil the performance requirements set in TS 38.133 [14]. For further details about the physical layer measurements, see TS 38.133 [14].
NOTE 4: For CLI-RSSI measurement, it is up to UE implementation whether to reset filtering upon BWP switch.
NOTE 5: For SSB measurements when multiple altitude range-based ssb-ToMeasure are configured, it is up to UE implementation whether to reset filtering upon entering a different altitude range.

### 5.5.3.3 Derivation of Cell Measurement Results

The network may configure the UE in RRC_CONNECTED to derive RSRP, RSRQ and SINR measurement results per cell associated to NR measurement objects based on parameters configured in the measObject (e.g. maximum number of beams to be averaged and beam consolidation thresholds) and in the reportConfig (rsType to be measured, SS/PBCH block or CSI-RS).

The network may configure the UE in RRC_IDLE or in RRC_INACTIVE to derive RSRP and RSRQ measurement results per cell associated to NR carriers based on parameters configured in measIdleCarrierListNR within VarMeasidleConfig for measurements performed according to 5.7.8.2a.

The UE shall:
1> for each cell measurement quantity to be derived based on SS/PBCH block:
   2> if nroJSS-BlocksToAverage is not configured in the associated measObject in RRC_CONNECTED or in the associated entry in measIdleCarrierListNR within VarMeasldleConfig in RRC_IDLE/RRC_INACTIVE; or
   2> if absThreshSS-BlocksConsolidation is not configured in the associated measObject in RRC_CONNECTED or in the associated entry in measIdleCarrierListNR within VarMeasldleConfig in RRC_IDLE/RRC_INACTIVE; or
   2> if the highest beam measurement quantity value is below or equal to absThreshSS-BlocksConsolidation:
      3> derive each cell measurement quantity based on SS/PBCH block as the highest beam measurement quantity value, where each beam measurement quantity is described in TS 38.215 [9];
   2> else:
      3> derive each cell measurement quantity based on SS/PBCH block as the linear power scale average of the highest beam measurement quantity values above absThreshSS-BlocksConsolidation where the total number of averaged beams shall not exceed nrojSS-BlocksToAverage, and where each beam measurement quantity is described in TS 38.215 [9];
   2> if in RRC_CONNECTED, apply layer 3 cell filtering as described in 5.5.3.2;
1> for each cell measurement quantity to be derived based on CSI-RS:
   2> consider a CSI-RS resource to be applicable for deriving cell measurements when the concerned CSI-RS resource is included in the csi-rs-CellMobility including the physCellId of the cell in the CSI-RS-ResourceConfigMobility in the associated measObject;
   2> if nrofCSI-RS-ResourcesToAverage in the associated measObject is not configured; or
   2> if absThreshCSI-RS-Consolidation in the associated measObject is not configured; or
   2> if the highest beam measurement quantity value is below or equal to absThreshCSI-RS-Consolidation:
      3> derive each cell measurement quantity based on applicable CSI-RS resources for the cell as the highest beam measurement quantity value, where each beam measurement quantity is described in TS 38.215 [9];
   2> else:
      3> derive each cell measurement quantity based on CSI-RS as the linear power scale average of the highest beam measurement quantity values above absThreshCSI-RS-Consolidation where the total number of averaged beams shall not exceed nrofCSI-RS-ResourcesToAverage;
   2> apply layer 3 cell filtering as described in 5.5.3.2.

### 5.5.4 Measurement Report Triggering

### 5.5.4.1 General

If AS security has been activated successfully, the UE shall:
1> for each measId included in the measIdList within VarMeasConfig:
   2> if the corresponding reportConfig includes a reportType set to eventTriggered or periodical:
      3> if the corresponding measObject concerns NR:
         4> if the eventA1 or eventA2 is configured in the corresponding reportConfig:
         5> consider only the serving cell to be applicable;
         4> if the eventA3 or eventA5 or eventA3H1 or eventA3H2 or eventA5H1 or eventA5H2 is configured in the corresponding reportConfig:
         5> if a serving cell is associated with a measObjectNR and neighbours are associated with another measObjectNR, consider any serving cell associated with the other measObjectNR to be a neighbouring cell as well;
         . . .
         4> if corresponding reportConfig includes reportType set to periodical; or
         4> for measurement events other than eventA1, eventA2, eventD1, eventD2, eventX2, eventH1 or eventH2:
         5> if useAllowedCellList is set to true:
         6> consider any neighbouring cell detected based on parameters in the associated measObjectNR to be applicable when the concerned cell is included in the allowedCellsToAddModList defined within the VarMeasConfig for this measId;
         5> else:
         6> consider any neighbouring cell detected based on parameters in the associated measObjectNR to be applicable when the concerned cell is not included in the excludedCellsToAddModList defined within the VarMeasConfig for this measId;
   2> if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig, while the VarMeasReportList does not include a measurement reporting entry for this measId (a first cell triggers the event):
      3> include a measurement reporting entry within the VarMeasReportList for this measId;
      3> set the numberOfReportsSent defined within the VarMeasReportList for this measId to 0; 3> include the concerned cell(s) in the cellsTriggeredList defined within the VarMeasReportList for this measId;
      3> if use T312 is set to true in reportConfig for this event:
         4> if T310 for the corresponding SpCell is running; and
         4> if T312 is not running for corresponding SpCell:
         5> start timer T312 for the corresponding SpCell with the value of T312 configured in the corresponding measObjectNR;
      3> initiate the measurement reporting procedure, as specified in 5.5.5;
   2> else if the reportType is set to eventTriggered, and if the corresponding reportConfig does not include numberOfTriggeringCells, and if the entry condition applicable for this event, i.e. the event corresponding with the eventId of the corresponding reportConfig within VarMeasConfig, is fulfilled for one or more applicable cells not included in the cellsTriggeredList for all measurements after layer 3 filtering taken during timeToTrigger defined for this event within the VarMeasConfig (a subsequent cell triggers the event):
      3> set the numberOfReportsSent defined within the VarMeasReportList for this measId to 0; 3> include the concerned cell(s) in the cellsTriggeredList defined within the VarMeasReportList for this measId;
      3> if use T312 is set to true in reportConfig for this event:
         4> if T310 for the corresponding SpCell is running; and
         4> if T312 is not running for corresponding SpCell:
         5> start timer T312 for the corresponding SpCell with the value of T312 configured in the corresponding measObjectNR;
      3> initiate the measurement reporting procedure, as specified in 5.5.5;
   2> if the reportType is set to eventTriggered, and if the corresponding reportConfig includes numberOfTriggeringCells, and if the entry condition applicable for this event, i.e. the event corresponding with the eventId of the corresponding reportConfig within VarMeasConfig, is fulfilled for one or more applicable cells for all measurements after layer 3 filtering taken during timeToTrigger defined for this event within the VarMeasConfig:
      3> if the VarMeasReportList does not include a measurement reporting entry for this measId (a first cell triggers the event):
         4> include a measurement reporting entry within the VarMeasReportList for this measId;
      3> if the number of cell(s) in the cellsTriggeredList is larger than or equal to numberOfTriggeringCells:
         4> include the concerned cell(s) in the cellsTriggeredList defined within the VarMeasReportList for this measId;
      3> else:
         4> include the concerned cell(s) in the cellsTriggeredList defined within the VarMeasReportList for this measId;
         4> if the number of cell(s) in the cellsTriggeredList is larger than or equal to numberOfTriggeringCells:
         5> set the numberOfReportsSent defined within the VarMeasReportList for this measId to 0;
         5> initiate the measurement reporting procedure, as specified in 5.5.5;
   2> if the reportType is set to eventTriggered and if the leaving condition applicable for this event is fulfilled for one or more of the cells included in the cellsTriggeredList defined within the VarMeasReportList for this measId for all measurements after layer 3 filtering taken during timeToTrigger defined within the VarMeasConfig for this event:
      3> remove the concerned cell(s) in the cellsTriggeredList defined within the VarMeasReportList for this measId;
      3> if reportOnLeave is set to true for the corresponding reporting configuration:
         4> if the corresponding reportConfig does not include numberOfTriggeringCells; or
         4> if the corresponding reportConfig includes numberOfTriggeringCells and a measurement report was previously sent to the network for at least one of the concerned cell(s):
         5> initiate the measurement reporting procedure, as specified in 5.5.5;
      3> if the cellsTriggeredList defined within the VarMeasReportList for this measId is empty:
         4> remove the measurement reporting entry within the VarMeasReportList for this measId;
         4> stop the periodical reporting timer for this measId, if running;
   2> if reportType is set to periodical and if a (first) measurement result is available:
      3> include a measurement reporting entry within the VarMeasReportList for this measId;
      3> set the numberOfReportsSent defined within the VarMeasReportList for this measId to 0;
      3> else if the reportAmount exceeds 1:
         4> initiate the measurement reporting procedure, as specified in 5.5.5, immediately after the quantity to be reported becomes available for the NR SpCell or for the serving L2 U2N Relay UE (if the UE is a L2 U2N Remote UE);
      3> else (i.e. the reportAmount is equal to 1):
         4> initiate the measurement reporting procedure, as specified in 5.5.5, immediately after the quantity to be reported becomes available for the NR SpCell and for the strongest cell among the applicable cells, or for the NR SpCell and for the strongest L2 U2N Relay UEs among the applicable L2 U2N Relay UEs; or initiate the measurement reporting procedure, as specified in 5.5.5, immediately after the quantity to be reported becomes available for the serving L2 U2N Relay UE and for the strongest cell among the applicable cells, or for the serving L2 U2N Relay UE and for the strongest L2 U2N Relay UEs among the applicable L2 U2N Relay UEs (if the UE is a L2 U2N Remote UE);
   2> upon expiry of the periodical reporting timer for this measId:
      3> initiate the measurement reporting procedure, as specified in 5.5.5.
         5.5.4.2 Event A1 (Serving Becomes Better than Threshold)

The UE shall:
1> consider the entering condition for this event to be satisfied when condition A1-1, as specified below, is fulfilled;
1> consider the leaving condition for this event to be satisfied when condition A1-2, as specified below, is fulfilled;
1> for this measurement, consider the NR serving cell corresponding to the associated measObjectNR associated with this event.

### Inequality A1-1 (Entering Condition)

$$Ms - Hys > Thresh$$

### Inequality A1-2 (Leaving Condition)

$$Ms + Hys < Thresh$$

The variables in the formula are defined as follows:
Ms is the measurement result of the serving cell, not taking into account any offsets.
Hys is the hysteresis parameter for this event (i.e. hysteresis as defined within reportConfigNR for this event).
Thresh is the threshold parameter for this event (i.e. a1-Threshold as defined within reportConfigNR for this event).
Ms is expressed in dBm in case of RSRP, or in dB in case of RSRQ and RS-SINR.
Hys is expressed in dB.
Thresh is expressed in the same unit as Ms.
   5.5.4.3 Event A2 (Serving Becomes Worse than Threshold)

The UE shall:
1> consider the entering condition for this event to be satisfied when condition A2-1, as specified below, is fulfilled;
1> consider the leaving condition for this event to be satisfied when condition A2-2, as specified below, is fulfilled;
1> for this measurement, consider the serving cell indicated by the measObjectNR associated to this event.
NOTE: If the SCell indicated by the measObjectNR associated to this event is not detectable, then the UE should consider for the value of Ms the lowest value of the value range of the measurement quantity as the SCell measurement.

### Inequality A2-1 (Entering Condition)

$$Ms + Hys < Thresh$$

### Inequality A2-2 (Leaving Condition)

$$Ms - Hys > Thresh$$

The variables in the formula are defined as follows:
Ms is the measurement result of the serving cell, not taking into account any offsets.
Hys is the hysteresis parameter for this event (i.e. hysteresis as defined within reportConfigNR for this event).
Thresh is the threshold parameter for this event (i.e. a2-Threshold as defined within reportConfigNR for this event).
Ms is expressed in dBm in case of RSRP, or in dB in case of RSRQ and RS-SINR.
Hys is expressed in dB.

Thresh is expressed in the same unit as Ms.

5.5.4.4 Event A3 (Neighbour Becomes Offset Better than SpCell)

The UE shall:
1> consider the entering condition for this event to be satisfied when condition A3-1, as specified below, is fulfilled;
1> consider the leaving condition for this event to be satisfied when condition A3-2, as specified below, is fulfilled;
1> use the SpCell for Mp, Ofp and Ocp.
NOTE 1: The cell(s) that triggers the event has reference signals indicated in the measObjectNR associated to this event which may be different from the NR SpCell measObjectNR.

### Inequality A3-1 (Entering Condition)

$$Mn + Ofn + Ocn - Hys > Mp + Ofp + Ocp + Off$$

### Inequality A3-2 (Leaving Condition)

$$Mn + Ofn + Ocn + Hys < Mp + Ofp + Ocp + Off$$

The variables in the formula are defined as follows:
Mn is the measurement result of the neighbouring cell, not taking into account any offsets.
Ofn is the measurement object specific offset of the reference signal of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the frequency of the neighbour cell, or cellIndividualOffset as defined within reportConfigNR), and set to zero if not configured for the neighbour cell.
Mp is the measurement result of the SpCell, not taking into account any offsets.
Ofp is the measurement object specific offset of the SpCell (i.e. offsetMO as defined within measObjectNR corresponding to the SpCell).
Ocp is the cell specific offset of the SpCell (i.e. cellIndividualOffset as defined within measObjectNR corresponding to the SpCell), and is set to zero if not configured for the SpCell.
Hys is the hysteresis parameter for this event (i.e. hysteresis as defined within reportConfigNR for this event).
Off is the offset parameter for this event (i.e. a3-Offset as defined within reportConfigNR for this event).
Mn, Mp are expressed in dBm in case of RSRP, or in dB in case of RSRQ and RS-SINR.
Ofn, Ocn, Ofp, Ocp, Hys, Off are expressed in dB.
NOTE 2: The definition of Event A3 also applies to CondEvent A3.
   5.5.4.5 Event A4 (Neighbour Becomes Better than Threshold)

The UE shall:
1> consider the entering condition for this event to be satisfied when condition A4-1, as specified below, is fulfilled;
1> consider the leaving condition for this event to be satisfied when condition A4-2, as specified below, is fulfilled.

### Inequality A4-1 (Entering Condition)

$$Ms + Ofn + Ocn - Hys > Thresh$$

### Inequality A4-2 (Leaving Condition)

$$Ms + Ofn + Ocn + Hys < Thresh$$

The variables in the formula are defined as follows:
Mn is the measurement result of the neighbouring cell or the measurement result of serving PSCell (i.e., in case it is configured as candidate PSCell for CondEvent A4 evaluation) for CHO with candidate SCG(s) case, not taking into account any offsets.
Ofn is the measurement object specific offset of the neighbour cell (i.e. offsetMO as defined within measObjectNR corresponding to the neighbour cell).
Ocn is the measurement object specific offset of the neighbour cell (i.e. cellIndividualOffset as defined within measObjectNR corresponding to the neighbour cell, or cellIndividualOffset as defined within reportConfigNR), and set to zero if not configured for the neighbour cell.
Hys is the hysteresis parameter for this event (i.e. hysteresis as defined within reportConfigNR for this event).
Thresh is the threshold parameter for this event (i.e. a4-Threshold as defined within reportConfigNR for this event).
Mn is expressed in dBm in case of RSRP, or in dB in case of RSRQ and RS-SINR.
Ofn, Ocn, Hys are expressed in dB.
Thresh is expressed in the same unit as Mn.
NOTE: The definition of Event A4 also applies to CondEvent A4.
   5.5.4.6 Event A5 (SpCell Becomes Worse than Threshold1 and Neighbour Becomes Better than Threshold2)

The UE shall:
1> consider the entering condition for this event to be satisfied when both condition A5-1 and condition A5-2, as specified below, are fulfilled;
1> consider the leaving condition for this event to be satisfied when condition A5-3 or condition A5-4, i.e. at least one of the two, as specified below, is fulfilled;
1> use the SpCell for Mp.
NOTE 1: The parameters of the reference signal(s) of the cell(s) that triggers the event are indicated in the measObjectNR associated to the event which may be different from the measObjectNR of the NR SpCell.

### Inequality A5-1 (Entering Condition 1)

$$Mp + Hys < Thresh 1$$

### Inequality A5-2 (Entering Condition 2)

$$Mn + Ofn + Ocn - Hys > Thresh 2$$

### Inequality A5-3 (Leaving Condition 1)

$$Mp - Hys > Thresh 1$$

### Inequality A5-4 (Leaving Condition 2)

$$Mn + Ofn + Ocn + Hys < Thresh 2$$

The variables in the formula are defined as follows:
Mp is the measurement result of the NR SpCell, not taking into account any offsets.
Mn is the measurement result of the neighbouring cell, not taking into account any offsets.
Ofn is the measurement object specific offset of the neighbour cell (i.e. offsetMO as defined within measObjectNR corresponding to the neighbour cell).
Ocn is the cell specific offset of the neighbour cell (i.e. cellIndividualOffset as defined within measObjectNR corresponding to the neighbour cell, or cellIndividualOffset as defined within reportConfigNR), and set to zero if not configured for the neighbour cell.
Hys is the hysteresis parameter for this event (i.e. hysteresis as defined within reportConfigNR for this event).
Thresh1 is the threshold parameter for this event (i.e. a5-Threshold1 as defined within reportConfigNR for this event).
Thresh2 is the threshold parameter for this event (i.e. a5-Threshold2 as defined within reportConfigNR for this event).
Mn, Mp are expressed in dBm in case of RSRP, or in dB in case of RSRQ and RS-SINR.
Ofn, Ocn, Hys are expressed in dB.
Thresh1 is expressed in the same unit as Mp.
Thresh2 is expressed in the same unit as Mn.
NOTE 2: The definition of Event A5 also applies to CondEvent A5.
   5.5.4.7 Event A6 (Neighbour becomes offset better than SCell)

The UE shall:
1> consider the entering condition for this event to be satisfied when condition A6-1, as specified below, is fulfilled;
1> consider the leaving condition for this event to be satisfied when condition A6-2, as specified below, is fulfilled;
1> for this measurement, consider the (secondary) cell corresponding to the measObjectNR associated to this event to be the serving cell.
NOTE: The reference signal(s) of the neighbour(s) and the reference signal(s) of the SCell are both indicated in the associated measObjectNR.

### Inequality A6-1 (Entering Condition)

$$Mn + Ocn - Hys > Ms + Ocs + Off$$

### Inequality A6-2 (Leaving Condition)

$$Mn + Ocn + Hys < Ms + Ocs + Off$$

The variables in the formula are defined as follows:
Mn is the measurement result of the neighbouring cell, not taking into account any offsets.
Ocn is the cell specific offset of the neighbour cell (i.e. cellIndividualOffset as defined within the associated measObjectNR), and set to zero if not configured for the neighbour cell.
Ms is the measurement result of the serving cell, not taking into account any offsets.
Ocs is the cell specific offset of the serving cell (i.e. cellIndividualOffset as defined within the associated measObjectNR, or cellIndividualOffset as defined within reportConfigNR), and is set to zero if not configured for the serving cell.
Hys is the hysteresis parameter for this event (i.e. hysteresis as defined within reportConfigNR for this event).
Off is the offset parameter for this event (i.e. a6-Offset as defined within reportConfigNR for this event).
Mn, Ms are expressed in dBm in case of RSRP, or in dB in case of RSRQ and RS-SINR.
Ocn, Ocs, Hys, Off are expressed in dB.

### 5.5.5 Measurement Reporting

### 5.5.5.1 General

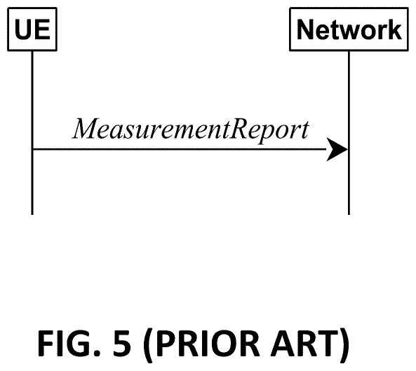

FIG. 5 is a Reproduction of FIG. 5.5.5.1-1: Measurement Reporting, from 3GPP TS 38.331 V18.1.0 (2024-03).

The purpose of this procedure is to transfer measurement results from the UE to the network. The UE shall initiate this procedure only after successful AS security activation.

For the measId for which the measurement reporting procedure was triggered, the UE shall set the measResults within the MeasurementReport message as follows:
1> set the measId to the measurement identity that triggered the measurement reporting;
1> for each serving cell configured with servingCellMO:
   2> if the reportConfig associated with the measId that triggered the measurement reporting includes rsType:
      3> if the serving cell measurements based on the rsType included in the reportConfig that triggered the measurement report are available:
         4> set the measResultServingCell within measResultServingMOList to include RSRP, RSRQ and the available SINR of the serving cell, derived based on the rsType included in the reportConfig that triggered the measurement report;
   2> else:
      3> if SSB based serving cell measurements are available:
         4> set the measResultServingCell within measResultServingMOList to include RSRP, RSRQ and the available SINR of the serving cell, derived based on SSB;
      3> else if CSI-RS based serving cell measurements are available:
         4> set the measResultServingCell within measResultServingMOList to include RSRP, RSRQ and the available SINR of the serving cell, derived based on CSI-RS;
1> set the servCellId within measResultServingMOList to include each NR serving cell that is configured with servingCellMO, if any;
1> if the reportConfig associated with the measId that triggered the measurement reporting includes reportQuantityRS-Indexes and maxNrofRS-IndexesToReport:
   2> for each serving cell configured with servingCellMO, include beam measurement information according to the associated reportConfig as described in 5.5.5.2;
1> if the reportConfig associated with the measId that triggered the measurement reporting includes reportAddNeighMeas:
   2> for each measObjectId referenced in the measIdList which is also referenced with servingCellMO, other than the measObjectId corresponding with the measId that triggered the measurement reporting:
      3> if the measObjectNR indicated by the servingCellMO includes the RS resource configuration corresponding to the rsType indicated in the reportConfig:
         4> set the measResultBestNeighCell within measResultServingMOList to include the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR;
         4> if the reportConfig associated with the measId that triggered the measurement reporting includes reportQuantityRS-Indexes and maxNrofRS-IndexesToReport:
         5> for each best non-serving cell included in the measurement report:
         6> include beam measurement information according to the associated reportConfig as described in 5.5.5.2;
1> if the reportConfig associated with the measId that triggered the measurement reporting is set to eventTriggered and eventID is set to eventA3, or eventA4, or eventA5, or eventB1, or eventB2, or eventA3H1, or eventA3H2, or eventA4H1, or eventA4H2, or eventA5H1, or eventA5H2:
   2> if the UE is in NE-DC and the measurement configuration that triggered this measurement report is associated with the MCG:
      3> set the measResultServFreqListEUTRA-SCG to include an entry for each E-UTRA SCG serving frequency with the following:
         4> include carrierFreq of the E-UTRA serving frequency;
         4> set the measResultServingCell to include the available measurement quantities that the UE is configured to measure by the measurement configuration associated with the SCG;
         4> if reportConfig associated with the measId that triggered the measurement reporting includes reportAddNeighMeas:
         5> set the measResultServFreqListEUTRA-SCG to include within measResultBestNeighCell the quantities of the best non-serving cell, based on RSRP, on the concerned serving frequency;
1> if reportConfig associated with the measId that triggered the measurement reporting is set to eventTriggered and eventID is set to eventA3, or eventA4, or eventA5, or eventA3H1, or eventA3H2, or eventA4H1, or eventA4H2, or eventA5H1, or eventA5H2:
   2> if the UE is in NR-DC and the measurement configuration that triggered this measurement report is associated with the MCG:
      3> set the measResultServFreqListNR-SCG to include for each NR SCG serving cell that is configured with servingCellMO, if any, the following:
         4> if the reportConfig associated with the measId that triggered the measurement reporting includes rsType:
         5> if the serving cell measurements based on the rsType included in the reportConfig that triggered the measurement report are available according to the measurement configuration associated with the SCG:
         6> set the measResultServingCell within measResultServFreqListNR-SCG to include RSRP, RSRQ and the available SINR of the serving cell, derived based on the rsType included in the reportConfig that triggered the measurement report;
         4> else:
         5> if SSB based serving cell measurements are available according to the measurement configuration associated with the SCG:
         6> set the measResultServingCell within measResultServFreqListNR-SCG to include RSRP, RSRQ and the available SINR of the serving cell, derived based on SSB;
         5> else if CSI-RS based serving cell measurements are available according to the measurement configuration associated with the SCG:
         6> set the measResultServingCell within measResultServFreqListNR-SCG to include RSRP, RSRQ and the available SINR of the serving cell, derived based on CSI-RS;
         4> if results for the serving cell derived based on SSB are included:
         5> include the ssbFrequency to the value indicated by ssbFrequency as included in the MeasObjectNR of the serving cell;
         4> if results for the serving cell derived based on CSI-RS are included:
         5> include the refFreqCSI-RS to the value indicated by refFreqCSI-RS as included in the MeasObjectNR of the serving cell;
         4> if the reportConfig associated with the measId that triggered the measurement reporting includes reportQuantityRS-Indexes and maxNrofRS-IndexesToReport:
         5> for each serving cell configured with servingCellMO, include beam measurement information according to the associated reportConfig as described in 5.5.5.2, where availability is considered according to the measurement configuration associated with the SCG;
         4> if reportConfig associated with the measId that triggered the measurement reporting includes reportAddNeighMeas:
         5> if the measObjectNR indicated by the servingCellMO includes the RS resource configuration corresponding to the rsType indicated in the reportConfig:
         6> set the measResultNeighCellListNR within measResultServFreqListNR-SCG to include one entry with the physCellId and the available measurement quantities based on the reportQuantityCell and rsType indicated in reportConfig of the non-serving cell corresponding to the concerned measObjectNR with the highest measured RSRP if RSRP measurement results are available for cells corresponding to this measObjectNR, otherwise with the highest measured RSRQ if RSRQ measurement results are available for cells corresponding to this measObjectNR, otherwise with the highest measured SINR, where availability is considered according to the measurement configuration associated with the SCG;
         7> if the reportConfig associated with the measId that triggered the measurement reporting includes reportQuantityRS-Indexes and maxNrofRS-IndexesToReport:
         8> for each best non-serving cell included in the measurement report:
         9> include beam measurement information according to the associated reportConfig as described in 5.5.5.2, where availability is considered according to the measurement configuration associated with the SCG;
1> if there is at least one applicable neighbouring cell or candidate L2 U2N Relay UE to report:
   2> if the reportType is set to eventTriggered or periodical:
      3> if the measurement report concerns the candidate L2 U2N Relay UE:
      3> else:
         4> set the measResultNeighCells to include the best neighbouring cells up to maxReportCells in accordance with the following:
         5> if the reportType is set to eventTriggered and eventId is not set to eventD1 or eventD2 or eventH1 or eventH2:
         6> include the cells included in the cellsTriggeredList as defined within the VarMeasReportList for this measId;
         5> else:
         6> include the applicable cells for which the new measurement results became available since the last periodical reporting or since the measurement was initiated or reset;
         5> for each cell that is included in the measResultNeighCells, include the physCellId;
         5> if the reportType is set to eventTriggered or periodical:
         6> for each included cell, include the layer 3 filtered measured results in accordance with the reportConfig for this measId, ordered as follows:
         7> if the measObject associated with this measId concerns NR:
         8> if rsType in the associated reportConfig is set to ssb:
         9> set resultsSSB-Cell within the measResult to include the SS/PBCH block based quantity(ies) indicated in the reportQuantityCell within the concerned reportConfig, in decreasing order of the sorting quantity, determined as specified in 5.5.5.3, i.e. the best cell is included first;
         9> if reportQuantityRS-Indexes and maxNrofRS-IndexesToReport are configured, include beam measurement information as described in 5.5.5.2;
         8> else if rsType in the associated reportConfig is set to csi-rs:
         9> set resultsCSI-RS-Cell within the measResult to include the CSI-RS based quantity(ies) indicated in the reportQuantityCell within the concerned reportConfig, in decreasing order of the sorting quantity, determined as specified in 5.5.5.3, i.e. the best cell is included first; 9> if reportQuantityRS-Indexes and maxNro)RS-IndexesToReport are configured, include beam measurement information as described in 5.5.5.2;
1> increment the numberOfReportsSent as defined within the VarMeasReportList for this measId by 1;
1> stop the periodical reporting timer, if running;
1> if the numberOfReportsSent as defined within the VarMeasReportList for this measId is less than the reportAmount as defined within the corresponding reportConfig for this measId:
   2> start the periodical reporting timer with the value of reportInterval as defined within the corresponding reportConfig for this measId;

### Next Quotation [3]

### MeasConfig

The IE MeasConfig specifies measurements to be performed by the UE, and covers intra-frequency, inter-frequency and inter-RAT mobility as well as configuration of measurement gaps.

MeasConfig information element

| | |
|---|---|
| MeasConfig ::= | SEQUENCE { |
| measObjectToRemoveList | MeasObjectToRemoveList |

OPTIONAL, -- Need N

| | |
|---|---|
| measObjectToAddModList | MeasObjectToAddModList |

OPTIONAL, -- Need N

| | |
|---|---|
| reportConfigToRemoveList | ReportConfigToRemoveList |

OPTIONAL, -- Need N

| | |
|---|---|
| reportConfigToAddModList | ReportConfigToAddModList |

OPTIONAL, -- Need N

| | |
|---|---|
| measIdToRemoveList | MeasIdToRemoveList |

OPTIONAL, -- Need N

| | |
|---|---|
| measIdToAddModList | MeasIdToAddModList |

OPTIONAL, -- Need N

| | |
|---|---|
| s-MeasureConfig | CHOICE { |
| ssb-RSRP | RSRP-Range, |
| csi-RSRP | RSRP-Range |

}
OPTIONAL, -- Need M

| | |
|---|---|
| quantityConfig | QuantityConfig |

OPTIONAL, -- Need M

| | |
|---|---|
| measGapConfig | MeasGapConfig |

OPTIONAL, -- Need M

| | |
|---|---|
| measGapSharingConfig | MeasGapSharingConfig |

```
OPTIONAL, -- Need M
  ...,
  [[
```

| | |
|---|---|
| interFrequencyConfig-NoGap-r16 | ENUMERATED {true} |

```
OPTIONAL -- Need R
  ]],
  [[
```

| | |
|---|---|
| effectiveMeasWindowConfig-r18 | SetupRelease {MeasWindowConfig-r18} |

OPTIONAL -- Need M
]]
}

| | |
|---|---|
| MeasObjectToRemoveList ::= | SEQUENCE (SIZE (1..maxNrofObjectId)) OF MeasObjectId |
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF ReportConfigId |

MeasConfig field descriptions

s-MeasureConfig
Threshold for NR SpCell RSRP measurement controlling when the UE is required to perform measurements on non-
serving cells. Choice of ssb-RSRP corresponds to cell RSRP based on SS/PBCH block and choice of csi-RSRP
corresponds to cell RSRP of CSI-RS.
. . .

### MeasIdToAddModList

The IE MeasIdToAddModList concerns a list of measurement identities to add or modify, with for each entry the measId, the associated measObjectId and the associated reportConfigId.

MeasIdToAddModList information element

| | |
|---|---|
| MeasIdToAddModList ::= | SEQUENCE (SIZE (1..maxNrofMeasId)) OF MeasIdToAddMod |
| MeasIdToAddMod ::= | SEQUENCE { |
| measId | MeasId, |
| measObjectId | MeasObjectId, |
| reportConfigId | ReportConfigId |

}
...

### MeasObjectToAddModList

The IE MeasObjectToAddModList concerns a list of measurement objects to add or modify.

MeasObjectToAddModList information element

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16, |
| measObjectNR-SL-r18 | MeasObjectNR-SL-r18 |

}
}
...

### ReportConfigNR

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;

ReportConfigNR information element

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| rxTxPeriodical-r17 | RxTxPeriodical-r17, |
| reportOnScellActivation-r18 | ReportOnScellActivation-r18 |

}
}
...

| | |
|---|---|
| EventTriggerConfig ::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    ...
  },
...
}
...
```

| | |
|---|---|
| CellIndividualOffsetList-r18 ::= | SEQUENCE { |
| physCellId-r18 | PhysCellId, |
| cellIndividualOffset-r18 | Q-OffsetRangeList |

}

EventTriggerConfig field descriptions

a3-Offset/a6-Offset
Offset value(s) to be used in NR measurement report triggering condition for event a3/a6. The actual value is field value
* 0.5 dB.
aN-ThresholdM
Threshold value associated to the selected trigger quantity (e.g. RSRP, RSRQ, SINR) per RS Type (e.g. SS/PBCH
block, CSI-RS) to be used in NR measurement report triggering condition for event number aN. If multiple thresholds
are defined for event number aN, the thresholds are differentiated by M. In the same eventA5, eventA5H1, eventA5H2,
the network configures the same quantity for the MeasTriggerQuantity of the a5-Threshold1 and for the
MeasTriggerQuantity of the a5-Threshold2.
channelOccupancyThreshold
RSSI threshold which is used for channel occupancy evaluation.
timeToTrigger
Time during which specific criteria for the event needs to be met in order to trigger a measurement report.
. . .

### ReportConfigToAddModList

The IE ReportConfigToAddModList concerns a list of reporting configurations to add or modify.

ReportConfigToAddModList information element

| | |
|---|---|
| ReportConfigToAddModList ::= | SEQUENCE (SIZE (1..maxReportConfigId)) OF ReportConfigToAddMod |
| ReportConfigToAddMod ::= | SEQUENCE { |
| reportConfigId | ReportConfigId, |
| reportConfig | CHOICE { |
| reportConfigNR | ReportConfigNR, |

...,

| | |
|---|---|
| reportConfigInterRAT | ReportConfigInterRAT, |
| reportConfigNR-SL-r16 | ReportConfigNR-SL-r16 |

}
}

### End of Quotation [3]

The current Layer 3 (L3) handover mechanism requires a User Equipment (UE) to measure certain reference signals indicated in the measurement object configuration. The measurement results are reported to the network periodically or are event-triggered when measurement results meet the configured threshold, Time-to-Trigger (TTT), hysteresis, and/or offset. The mechanism is reactive in its nature; therefore, a handover can only be initiated when the UE measurement implies a bad radio condition, which may be too late and lead to Radio Link Failure (RLF). Artificial Intelligence/Machine Learning (AI/ML or AIML) models may be used to predict the signal strength of reference signals/set of beams in the future based on historical measurements, the signal strength of another reference signal/set of beams based on one reference signal/set of beams, measurement report triggering events and RLF/Handover Failure (HOF). The prediction may be inter-frequency or intra-frequency, inter-cell or intra-cell (i.e., the input and the output of the model are from different frequencies/cells, the input may also contain beams/cells from different frequencies/cells). The input to an AI/ML model may be Layer 1 (L1) beam measurement or L3 cell level measurement, predicted or measured. The output of an AI/ML model may be L1 beam measurement or L3 cell level measurement. The prediction of AI/ML models may be proactive (i.e., before the UE measurement implies a bad radio condition); subsequently improving the performance of handover. Also, with the assistance of AI/ML models, measurement overhead (e.g., Reference Signal (RS) transmission, measurement gap, and UE measurement effort) may be reduced.

In the latest New Radio (NR) release 18, measurement is performed by the UE following a Network (NW) configuration. The NW configures measurement object(s), report configuration(s), and measurement identity/identities to a UE. A measurement identity associates one measurement object with one report configuration. The UE measures the serving cell(s) and cell(s) associated with report configuration(s) when there is at least one report configuration associated with a measurement identity and conditions such as measurement gaps or threshold restrictions are met.

In NR release 19, several AI/ML enhancements to mobility have been introduced as study items. These enhancements include temporal or spatial predictions of intra and inter-frequency cell-level measurement, and inter-cell beam-level measurement, Handover (HO) failure/RLF prediction and measurement report triggering event prediction.

In addition to studies on AI/ML enhancements to mobility, a general signaling framework for Life Cycle Management (LCM) of AI/ML functionality for a UE-sided model is being discussed. The initial step for a UE to perform AI/ML functionality includes signaling of supported functionalities, applicable functionalities, and the activation of functionalities. According to the [4][POST126][032][AI/ML PHY] email discussion on LCM, the definitions for the functionality states can be summarized as follows:
Supported functionalities: refers to functionalities that the UE can indicate by using UE capability signaling.
Applicable functionalities: refers to functionalities that the UE is ready to apply for model inference.
Activated functionalities: refers to functionalities already activated and performing inference.

A UE may first report the supported functionalities upon an NW enquiry. The applicable functionalities may be determined (e.g., by the UE) based on the supported functionalities. The functionalities may be activated (e.g., by the UE/NW) to perform inference after they are determined to be applicable. The activation of an AI/ML functionality may be to start performing inference. The deactivation of an AI/ML functionality may be to stop performing inference.

A supported functionality may not be always applicable. For example, a UE may not have the model yet. For another example, an AI/ML model may (only) be applicable at certain conditions, an AI/ML model may be designed for specific use cases which the current status does not meet.

An applicable functionality may not be always activated. For example, measurement for some cells may not be required when the radio condition is good. Consequently, an AI/ML functionality for measurement may not be activated.

When the AI/ML functionality is activated for mobility (e.g., measurement prediction), the legacy measurement configuration may not be suitable. For example, when a measurement is predicted (instead of measured), it may not be suitable to maintain the same measurement configuration and make a UE perform the measurement that is not needed. For example, when the UE is capable of performing consecutive predictions in time domain, using the same TTT as legacy is not suitable.

In Radio Resource Management (RRM) measurement prediction, the UE can predict measurement results of future time instances.

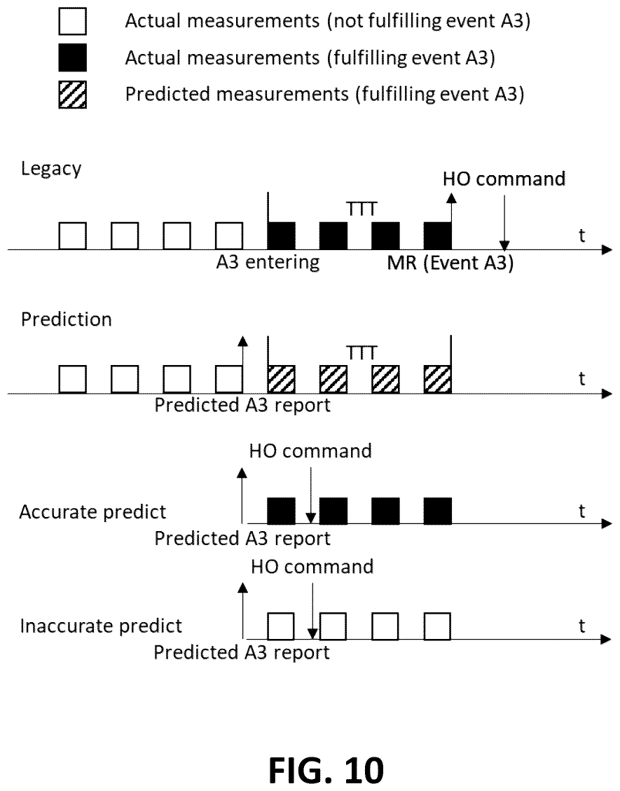

The predicted measurement results can be used to predict the happening of a measurement event in a future time instance. However, the predicted measurement results may not be 100% accurate, such inaccuracy may result in an inappropriate measurement event being triggered and reported to the network, causing handover failure (e.g., too early handover, wrong handover/cell) when performing handover based on the inaccurate report. Such failure impacts the network performance and may lead to disconnections, and further wasting the UE's limited power. An example is showed in FIG. 10.

To at least solve the issues described above, at least some of the methods, embodiments, and examples described below could be considered.

In the following, the “measurement report triggering event” may be or be replaced by a “measurement event”, a “measurement report event”, or a “measurement reporting event”. In the following, the “AI/ML functionality” may be or be replaced by an “AI/ML function”, an “AI/ML assisted mobility”, an “AI/ML assisted measurement”, an “AI/ML enhanced mobility”, an “AI/ML enhanced measurement”, a “functionality”, or a “function”.

A UE may report its applicable functionalit(ies) to a NW, e.g., before/after AI/ML functionality is configured and/or activated, before/after signaling for configuration and/or activation is received. The NW may configure or signal the related functionalit(ies) and configuration(s), e.g., in response to receiving the report from the UE. The configurations and signaling may be used to provide support to an AI/ML functionality, e.g., model parameters and/or configurations for measurement, and/or to perform functionality/model selection, activation, deactivation, switching, and/or fallback operation.

At least one or more of the following may be considered when determining the applicable functionalit(ies) and/or performing action(s)/operation(s) (e.g., functionality/model selection, activation, deactivation, switching, and/or fallback operation of one or more (AI/ML) functionalit(ies) and/or actions related to measurement (e.g., enabling/disabling a measurement/measurement report triggering event, adjusting measurement report triggering event parameters such as a threshold, TTT, hysteresis, offset)): location, distance to a serving cell, moving speed, serving/current beam(s), quality of cell, quality of serving/current beam(s), likelihood of handover/RLF/beam failure/measurement event, model performance, and/or etc. The UE may determine to activate (or deactivate) an AI/ML functionality based on at least one of them.

### Location

A location may indicate the current location of a UE, a previous location of a UE, the location of a NW, the serving area of a cell, a country, a city, a district, a Public Land Mobile Network (PLMN), an area, a trajectory, a path. A location may be indicated by an Identification/Identity (ID), identifier, index (of a site, cell, UE, NW and/or any of the locations listed above) and/or as specified in a spec. A location may be a geographic location. A location may be in an area level, e.g., indicated by an area ID. A location may be a reference location (e.g., to a reference point).

### Distance to Serving Cell

A serving cell may be a Primary Cell (PCell), Primary Secondary Cell (PSCell), Special Cell (SpCell), activated Secondary Cell (SCell), deactivated SCell, candidate PCell, candidate PSCell, candidate SpCell, candidate SCell, non-serving cell, neighbouring cell. A distance may be derived by a UE or a NW. Location information of a UE or a serving cell may be provided by the NW or the UE to assist the derivation of distance. A distance to the serving cell may be (or indicate) the distance between the UE and a reference location of the serving cell. The reference location may be a pre-defined location, e.g., cell center.

### Moving Speed

A moving speed may be derived by UE location. A moving speed may be an absolute speed or relative speed, e.g., to a cell or site. The moving speed may be positive or negative. The moving speed may be an average speed across a time period. A NW may provide a configuration to specify the time period or parameters to perform moving speed derivation. The moving speed may be in a speed level, e.g., high, medium, low.

### Serving/Current Beam(s)

Beam(s)/Cell(s) may be (from) a serving cell or non-serving cell. Beam(s)/Cell(s) may be associated with (indicated as) measurement object(s), report configuration(s), measurement identity/identities, Transmission Configuration Indicator (TCI) state(s), Synchronization Signal Block(s) (SSB(s) (SS/PBCH Block(s)), Channel State Information Reference Signal(s) (CSI-RS(s)), and/or CSI configuration(s).

### Quality of Cell

A cell may be a PCell, PSCell, SpCell, activated SCell, deactivated SCell, candidate PCell, candidate PSCell, candidate SpCell, candidate SCell, non-serving cell, neighbouring cell. The (Quality of) Cell(s) may be associated with (indicated as) measurement object(s), report configuration(s), measurement identity/identities, TCI state(s), SSB(s), CSI-RS(s), CSI configuration(s), and/or beam(s) from cell(s). The quality of cell(s) may be from an actual measurement or an AI/ML prediction. The quality of cell(s) may be a radio condition and/or a measurement result of the cell(s).

### Quality of Serving/Current Beam(s)

The (Quality of) Beam(s) may be associated with (indicated as) measurement object(s), report configuration(s), measurement identity/identities, TCI state(s), SSB(s), CSI-RS(s), and/or CSI configuration(s). The quality of beam(s) may be from an actual measurement or an AI/ML prediction. The quality of beam(s) may be a radio condition and/or a measurement result of the beam(s).

### Likelihood of Handover/RLF/Beam Failure/Measurement Event

A UE may predict the likelihood/probability of handover/RLF/beam failure/measurement event. The likelihood may be in a percentage level, e.g., 30%, 50%, 80%. The likelihood may be in a likelihood level, e.g., high, medium, low. The likelihood may indicate the chance of occurrence of a specific event, e.g., handover, RLF, beam failure, measurement event.

### Model Performance

A UE may evaluate the performance of AI/ML model(s) or functionalit(ies) by calculating the difference between prediction and a ground truth. Model performance/prediction/ground truth may be signal strength (e.g., Reference Signal Received Power (RSRP), Reference Signal Received Quality (RSRQ), Signal-to-Interference and Noise Ratio) SINR), probability/likelihood of handover/RLF/beam failure/measurement event, probability/likelihood of a measurement report triggering event. Model performance may be the prediction. Model performance may be in a percentage level, e.g., 30%, 50%, 80%. Model performance may be in a performance level, e.g., high, medium, low. Ground truth may be an actual measurement and/or from a dataset (provided by vendor and/or NW).

The operation of AI/ML assisted mobility (e.g., the evaluation of conditions for determining the applicable functionalities and the activation of the functionalities) may be at the UE-side (e.g., option 1), the NW-side (e.g., option 2), or jointly by the UE and the NW (e.g., combined option 1 and 2).

Option 1: A NW may provide a configuration which includes condition(s) to evaluate (e.g., threshold(s)). This may be applicable for the case that the evaluation happens at the UE-side. The applicable functionalities, functionality/model selection, activation, deactivation, switching, and/or fallback operation of functionalities and/or actions related to measurement (e.g., enabling/disabling a measurement/measurement report triggering event, adjusting measurement report triggering event parameters such as a threshold, TTT, hysteresis, offset) may depend on the fulfillment of a configured condition.

A UE may determine to activate (or deactivate) a function, enable (or disable) a measurement, enable (or disable) a measurement report triggering event, and/or adjust a parameter (e.g., for a measurement report triggering event) based on a configured condition. For example, if a UE determines that a configured condition is fulfilled, the UE may activate (or deactivate) a function, enable (or disable) a measurement, enable (or disable) a measurement report triggering event, and/or adjusting a parameter. For example, if a UE determines that a configured condition is not fulfilled, the UE may deactivate (or activate) a function, disable (or enable) a measurement, disable (or enable) a measurement report triggering event, and/or adjusting a parameter.

The outcome of the evaluation may or may not be reported to the NW. The NW may reconfigure the UE if the outcome is received.

Option 2: A NW may provide a configuration which includes (additional) condition(s)/information (that the NW is not aware of) to report. This may be applicable for the case that the evaluation happens at the NW-side. AUE may report the (additional) condition(s)/information to a NW in a response to a NW inquiry or trigger proactively when (or in response to) a condition is met (e.g., upon change of (additional) condition(s)/information). The trigger condition(s) may or may not be configured by the NW. With the reported (additional) condition(s)/information, the NW may decide the applicable functionalities, functionality/model selection, activation, deactivation, switching, and/or fallback operation of functionalities and/or actions related to measurement (e.g., enabling/disabling a measurement/measurement report triggering event, adjusting measurement report triggering event parameters such as threshold, TTT, hysteresis, offset), and reconfigure the UE (to reflect the NW decision(s)).

Combined option 1 and option 2: Option 1 may be combined with option 2. For example, the NW may provide a configuration which includes condition(s) to evaluate and (additional) condition(s)/information to report. The UE may perform evaluation based on the configuration, and/or report the outcome and/or (additional) condition(s)/information to the NW. The outcome and/or (additional) condition(s)/information may or may not be in the same message or reported in the same way, e.g., multiple messages may be used. The UE may also perform some operations such as measurement related actions, functionality/model selection, activation, deactivation, switching, and/or fallback operation. The NW may also reconfigure the UE after receiving the outcome and (additional) condition(s)/information.

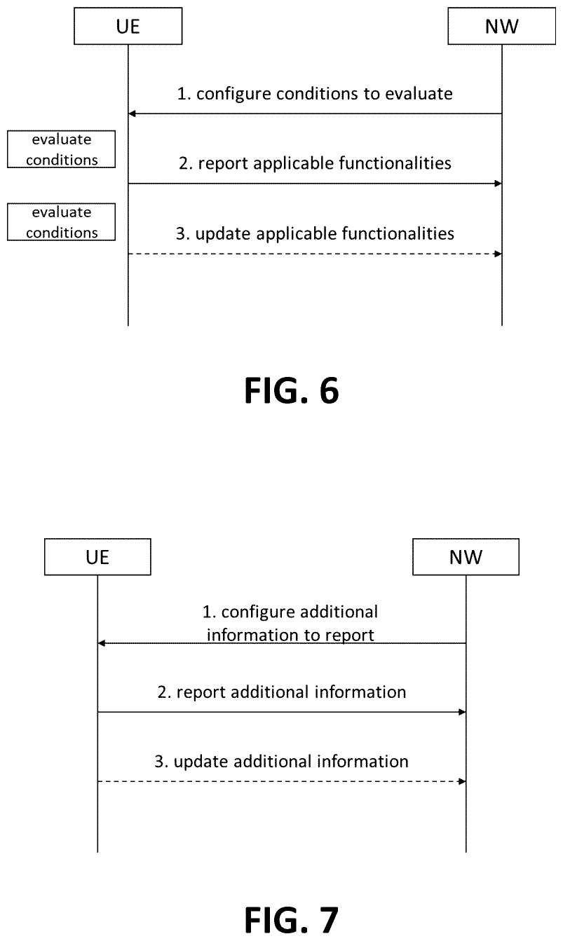

A first procedure may be used to indicate applicable functionalities of a UE to a NW. An example of the first procedure is shown in FIG. 6 and FIG. 7. The first procedure may include a first message, e.g., from the NW to the UE, to inquire the applicable functionalities and/or configure the UE to perform AI/ML functionalit(ies). The first procedure may include a second message, e.g., from the UE to the NW, to report the applicable functionalities and/or the current status of the UE. A third message may be transmitted from the UE to the NW including updated applicable functionalities and/or the current status of the UE, e.g., when the applicable functionalities and/or the current status of the UE changes.

The first procedure may be performed based on a UE decision of applicable functionalities (e.g., option 1 described above). An example is shown below:

The UE may receive a first message from the NW. The first message may include condition(s) and/or threshold(s) to evaluate the applicable functionalities. The first message may include trigger condition(s) to perform a report/transmit a message to the NW.

The UE may, based on the condition(s) and/or threshold(s) to evaluate the applicable functionalities included in the first message, decide whether the UE is applicable of an AI/ML functionality (e.g., the UE meets the condition(s) and/or may be above/below threshold(s) to be applicable/not applicable of a functionality). The conditions may include at least one of: location, distance to a serving cell, moving speed, serving/current beam(s), quality of cell, quality of serving/current beam(s), likelihood of handover/RLF/beam failure/measurement event, model performance, and/or etc.

The UE may transmit a second message to the NW. The second message may include the fulfillment of each condition(s) and/or threshold(s) to evaluate the applicable functionalities received in the first message.

The second message may include the current status related to each condition(s) and/or threshold(s) to evaluate the applicable functionalities received in the first message. The second message may include the applicable functionalities.

The second message may be event triggered (e.g., upon current status change) and/or periodically triggered following the specification or the first message (e.g., UE Assistance Information (UAI)). The trigger conditions may include at least one of: location, distance to a serving cell, moving speed, serving/current beam(s), quality of cell, quality of serving/current beam(s), likelihood of handover/RLF/beam failure/measurement event, model performance, and/or etc. The second message may be a response to the first message (e.g., RRCReconfigurationComplete), wherein RRC means Radio Resource Control. The second message may be transmitted multiple times, with different/updated content. The second message may be a third message.

Alternatively and/or additionally in certain embodiments, the first procedure may be performed based on a NW decision of applicable functionalities (e.g., option 2 described above). An example is shown below:

The UE may receive a first message from the NW. The first message may indicate/configure (additional) information to report to the NW. The first message may include trigger condition(s) to perform a report/transmit a message to the NW.

The UE may transmit a second message to the NW. The second message may include the (additional) information indicated in the first message. The (additional) information may include at least one of: location, distance to a serving cell, moving speed, serving/current beam(s), quality of cell, quality of serving/current beam(s), likelihood of handover/RLF/beam failure/measurement event, model performance, and/or etc. The second message may include the quantity of each reported information.

The second message may be event triggered (e.g., upon current status change) and/or periodically triggered following the specification or the first message (e.g., UAI). The trigger conditions may include at least one of: location, distance to a serving cell, moving speed, serving/current beam(s), quality of cell, quality of serving/current beam(s), likelihood of handover/RLF/beam failure/measurement event, model performance, and/or etc. The second message may be a response to the first message (e.g., RRCReconfigurationComplete). The second message may be transmitted multiple times, with different/updated content. The second message may be a third message.

More details of the first procedure are described below. One or more features in different examples may be combined as another example, in whole or in part.

The UE may, according to the condition(s) to evaluate included in the first message, decide whether the UE is applicable of an AI/ML functionality and report to the NW. The report may be through UAI or through a response message such as RRCReconfigurationComplete. The conditions may include at least one of: location, distance to a serving cell, moving speed, serving/current beam(s), quality of cell, quality of serving/current beam(s), likelihood of handover/RLF/beam failure/measurement event, model performance, and/or etc.

### Location

The NW may provide an indication to the location and/or provide an inquiry of location to the UE. The UE may consider AI/ML functionality applicable or activate the AI/ML functionality when/if (at least)/in response to the UE location meets the provided indication and/or inquiry.

### Distance to a Serving Cell

The NW may configure threshold(s) for the distance to serving cell(s) for the UE. The UE may consider AI/ML functionality applicable or activate the AI/ML functionality when/if (at least)/in response to the UE distance to serving cell(s) is above or below the threshold(s).

### Moving Speed

The NW may configure threshold(s) for the moving speed of the UE. The UE may consider AI/ML functionality applicable or activate the AI/ML functionality when/if (at least)/in response to the UE moving speed is above or below the threshold(s).

### Serving/Current Beam(s)

The NW may provide an indication to beam(s)/cell(s) to the UE. The UE may consider AI/ML functionality applicable or activate the AI/ML functionality when/if (at least)/in response to the indicated beam(s)/cell(s) is the current/serving beam(s)/cell(s) or when/if (at least)/in response to the indicated beam(s)/cell(s) is measured by UE and/or configured to UE.

### Quality of Cell

The NW may configure threshold(s) for the quality of cell(s) for the UE. The UE may consider AI/ML functionality applicable or activate the AI/ML functionality when/if (at least)/in response to the quality of cell(s) is above or below the threshold(s).

### Quality of Serving/Current Beam(s)

The NW may configure threshold(s) for the quality of beam(s) for the UE. The UE may consider AI/ML functionality applicable or activate the AI/ML functionality when/if (at least)/in response to the quality of beam(s) is above or below the threshold(s).

### Likelihood of Handover/RLF/Beam Failure/Measurement Event

The NW may configure threshold(s) for the likelihood/probability of handover/RLF/beam failure/measurement event for the UE. The UE may consider AI/ML functionality applicable or activate the AI/ML functionality when/if (at least)/in response to the likelihood of handover/RLF/beam failure/measurement event is above or below the threshold(s).

### Model Performance

The NW may configure threshold(s) for the performance of AI/ML model(s) for the UE. The UE may consider AI/ML functionality applicable or activate the AI/ML functionality when/if (at least)/in response to the performance of AI/ML model(s) is above or below the threshold(s).

The UE may, according to the (additional) information to report indicated/configured in the first message, report the (additional) information to the NW. The report may be through UAI or through a response message such as RRCReconfigurationComplete. The (additional) information may include at least one of: location, distance to a serving cell, moving speed, serving/current beam(s), quality of cell, quality of serving/current beam(s), likelihood of handover/RLF/beam failure/measurement event, model performance, and/or etc.

### Location

The NW may provide an indication to the location and/or provide an inquiry of location to the UE. The UE may report an indication of the location or response to the inquiry of location to the NW.

### Distance to Serving Cell

The NW may configure the serving cell(s) for the UE to report the distance. The UE may report the distance to the serving cell(s) to the NW.

### Moving Speed

The NW may configure the UE to report its moving speed. The UE may report its moving speed to the NW.

### Serving/Current Beam(s)

The NW may provide an indication to the beam(s)/cell(s) to the UE. The UE may report an indication of the beam(s)/cell(s) to the UE to the NW.

### Quality of Cell

The NW may configure the cell(s) for the UE to report the quality. The UE may report the quality of the cell(s) to the NW.

### Quality of Serving/Current Beam(s)

The NW may configure the beam(s) for the UE to report the quality. The UE may report the quality of the beam(s) to the NW.

### Likelihood of Handover/RLF/Beam Failure/Measurement Event

The NW may configure the UE to report its likelihood/probability of handover/RLF/beam failure/measurement event. The UE may report its likelihood/probability of handover/RLF/beam failure/measurement event to the NW.

### Model Performance

The NW may configure the UE to report the performance of AI/ML model(s). The UE may report the performance of AI/ML model(s) to the NW.

The AI/ML functionality may be activated upon configuration, through signaling from the NW (e.g., Radio Resource Control (RRC) message, Medium Access Control (MAC) signaling, Physical Layer (PHY) signaling, paging, broadcasting, dedicated or non-dedicated) and/or by the UE when certain conditions are met. Functionality/model selection, activation, deactivation, switching, and/or fallback operation may be upon configuration, through signaling from the NW (e.g., RRC message, MAC signaling, PHY signaling, paging, broadcasting, dedicated or non-dedicated) and/or by the UE when certain conditions are met.

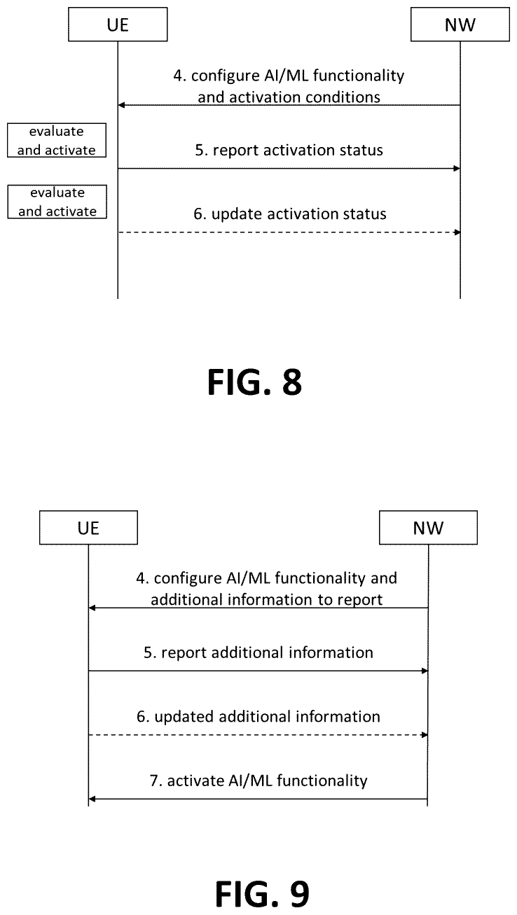

A second procedure may be used to perform functionality/model selection, activation, deactivation, switching, and/or fallback operation of an AI/ML functionality and/or perform measurement related actions on a UE. An example of the second procedure is shown in FIG. 8 and FIG. 9. The second procedure may include a fourth message (e.g., a first message of a second procedure), e.g., from the NW to the UE, which includes configuration(s) for AI/ML functionality (e.g., model parameters and/or configurations for measurement). The second procedure may include a fifth message (e.g., a second message of a second procedure), e.g., from the UE to the NW, to report the current status of the UE, e.g., activation status of functionality. A sixth message (e.g., a third message of a second procedure) may be transmitted from the UE to the NW including an updated current status of the UE, e.g., when the current status of the UE changes. The second procedure may include a seventh message (e.g., a fourth message of a second procedure), e.g., from the NW to the UE, to perform functionality/model selection, activation, deactivation, switching, and/or fallback operation of an AI/ML functionality.

The second procedure may be performed based on a UE decision of functionality/model selection, activation, deactivation, switching, and/or fallback operation (e.g., option 1 described above). An example is shown below:

In this example, the NW may configure condition(s) to evaluate in a fourth message (e.g., the first message of a second procedure). The UE may perform functionality/model selection, activation, deactivation, switching, and/or fallback operation of an AI/ML functionality according to the configured conditions in the fourth message (e.g., the first message of a second procedure). The UE may report the decision of functionality/model selection, activation, deactivation, switching, and/or fallback operation to the NW through a fifth message (e.g., the second message of a second procedure).

The UE may receive a fourth (e.g., the first message of a second procedure) message from the NW. The fourth (e.g., the first message of a second procedure) message may include condition(s) and/or threshold(s) to evaluate functionality/model selection, activation, deactivation, switching, and/or fallback operation of an AI/ML functionality and/or action(s) related to measurement (e.g., enabling/disabling a measurement/measurement report triggering event, adjusting measurement report triggering event parameters such as a threshold, TTT, hysteresis, offset). The fourth (e.g., the first message of a second procedure) message may include configuration(s) for AI/ML functionality (e.g., model parameters) and trigger condition(s) to perform a report/transmit a message to the NW.

The UE may, based on the condition(s) and/or threshold(s) to evaluate functionality/model selection, activation, deactivation, switching, and/or fallback operation of an AI/ML functionality and/or action(s) related to measurement included in the fourth (e.g., the first message of a second procedure) message, decide whether to perform functionality/model selection, activation, deactivation, switching, and/or fallback operation of an AI/ML functionality and/or perform action(s) related to measurement (e.g., the UE meets the condition(s) and/or is above/below threshold(s) to activate a functionality, perform operations and/or perform actions). The condition(s) may include at least one of: location, distance to a serving cell, moving speed, serving/current beam(s), quality of cell, quality of serving/current beam(s), likelihood of handover/RLF/beam failure/measurement event, model performance, and/or etc. The condition(s)/threshold(s) may be specified individually for each functionality/model selection, activation, deactivation, switching, and/or fallback operation of an AI/ML functionality, for each action related to measurement, or shared between activation and actions. The condition(s)/threshold(s) may be specified individually for each action or shared between. The action(s) may include enabling/disabling a measurement/measurement report triggering event, adjusting measurement report triggering event parameters such as a threshold, TTT, hysteresis, offset.

The UE may be configured with a first (measurement) configuration before/upon/after functionality/model selection, activation, deactivation, switching, and/or fallback operation of an AI/ML functionality. The UE may use a second (measurement) configuration for AI/ML functionality. The second (measurement) configuration may be included in the fourth (e.g., the first message of a second procedure) message. The second (measurement) configuration may be a separate configuration or an extension to the first (measurement) configuration. The second (measurement) configuration may include measurement object(s), report configuration(s), measurement identity/identities. The second (measurement) configuration may include modifications/adjustments to the first (measurement) configuration. The modifications/adjustments may include a subset of beams to measure/skip, the time to measure/skip, the frequency to measure/skip, offset or scaling factors to a threshold, hysteresis, TTT, offset for measurement report triggering event.

A measurement object in the second (measurement) configuration may be associated with a measurement object in the first (measurement) configuration. A report configuration in the second (measurement) configuration may be associated with a report configuration in the first (measurement) configuration. A measurement identity in the second (measurement) configuration may be associated with a measurement identity in the first (measurement) configuration. A modification/adjustment may be associated with a measurement object, a report configuration, a measurement identity. The association may be indicated by using the same ID(s), extra ID(s)/index(indices)/parameter(s), and/or specified in the specification. The association may be a one-to-one, one-to-many, many-to-one mapping.

When the condition(s) and/or threshold(s) to evaluate an action related to measurement included in the fourth message (e.g., the first message of a second procedure) is met, the UE may use/apply the second (measurement) configuration. The second (measurement) configuration may be applied partially (i.e., only apply the configurations associated with the action whose condition(s) and/or threshold(s) are fulfilled).

When the condition(s) and/or threshold(s) to evaluate an action related to measurement included in the fourth message (e.g., the first message of a second procedure) is met, the UE may ignore/revert the first (measurement) configuration. The first (measurement) configuration may be ignored/reverted partially (e.g., ignore some of the configurations associated with the action whose condition(s) and/or threshold(s) are fulfilled).

The UE may transmit a fifth (e.g., the second message of a second procedure) message to the NW. The fifth (e.g., the second message of a second procedure) message may include the fulfillment of each condition(s) and/or threshold(s) to evaluate the functionality/model selection, activation, deactivation, switching, and/or fallback operation of an AI/ML functionality and/or action(s) related to the measurement received in the fourth (e.g., the first message of a second procedure) message. The fifth (e.g., the second message of a second procedure) message may include the current status related to each condition(s) and/or threshold(s) to evaluate functionality/model selection, activation, deactivation, switching, and/or fallback operation of an AI/ML functionality and/or action(s) related to the measurement received in the fourth (e.g., the first message of a second procedure) message. The fifth (e.g., the second message of a second procedure) message may indicate/include current status of functionality/model selection, activation, deactivation, switching, and/or fallback operation of an AI/ML functionality, and/or the measurement configuration. The fifth (e.g., the second message of a second procedure) message may include the quantity of each reported information. The fifth (e.g., the second message of a second procedure) message may be an RRC message, MAC signaling or PHY signaling.

The fifth (e.g., the second message of a second procedure) message may be event triggered (e.g., upon a current status change) and/or periodically triggered following the specification or the fourth (e.g., the first message of a second procedure) message (e.g., UAI). The trigger condition(s) may include at least one of: location, distance to a serving cell, moving speed, serving/current beam(s), quality of cell, quality of serving/current beam(s), likelihood of handover/RLF/beam failure/measurement event, model performance, and/or etc. The fifth (e.g., the second message of a second procedure) message may be a response to the first message (e.g., RRCReconfigurationComplete). The fifth (e.g., the second message of a second procedure) message may be transmitted multiple times, with different/updated content. The fifth (e.g., the second message of a second procedure) message may be a sixth (e.g., the third message of a second procedure) message.

The second procedure may be performed based on the NW decision of functionality/model selection, activation, deactivation, switching, and/or fallback operation (e.g., option 2 described above). An example is shown below:

In this example, the NW may indicate/configure (additional) information to report and/or configuration for AI/ML functionality in a fourth message (e.g., the first message of a second procedure). The UE may transmit a fifth message (e.g., the second message of a second procedure) comprising the (additional) information based the configuration included the fourth message (e.g., the first message of a second procedure). The UE may transmit a sixth message (e.g., the third message of a second procedure) to the NW and then perform functionality/model selection, activation, deactivation, switching, and/or fallback operation of an AI/ML functionality through a seventh message (e.g., the third message of a second procedure) (e.g., RRC message, MAC signaling, PHY signaling).

The UE may receive a fourth (e.g., the first message of a second procedure) message from the NW. The fourth (e.g., the first message of a second procedure) message may indicate/configure (additional) information to report and/or action(s) related to measurement (e.g., enabling/disabling a measurement/measurement report triggering event, adjusting measurement report triggering event parameters such as a threshold, TTT, hysteresis, offset). The fourth (e.g., the first message of a second procedure) message may include configuration(s) for AI/ML functionality (e.g., model parameters) and trigger condition(s) to perform a report/transmit a message to the NW.

The UE may transmit a fifth (e.g., the second message of a second procedure) message to the NW. The fifth (e.g., the second message of a second procedure) message may include the (additional) information indicated/configured in the fourth (e.g., the first message of a second procedure) message. The (additional) information may include at least one of: location, distance to a serving cell, moving speed, serving/current beam(s), quality of cell, quality of serving/current beam(s), likelihood of handover/RLF/beam failure/measurement event, model performance, and/or etc. The fifth (e.g., the second message of a second procedure) message may include the quantity of each reported information.

The fifth (e.g., the second message of a second procedure) message may be event triggered (e.g., upon current status change) and/or periodically triggered following the specification or the fourth (e.g., the first message of a second procedure) message (e.g., UAI). The trigger condition(s) may include at least one of: location, distance to a serving cell, moving speed, serving/current beam(s), quality of cell, quality of serving/current beam(s), likelihood of handover/RLF/beam failure/measurement event, model performance, and/or etc. The fifth (e.g., the second message of a second procedure) message may be a response to the fourth (e.g., the first message of a second procedure) message (e.g., RRCReconfigurationComplete). The fifth (e.g., the second message of a second procedure) message may be transmitted multiple times, with different/updated content. The fifth (e.g., the second message of a second procedure) message may be a sixth (e.g., the third message of a second procedure) message.

The UE may receive a seventh (e.g., the fourth message of a second procedure) message from the NW. The seventh (e.g., the third message of a second procedure) message may be an RRC message, MAC signaling or PHY signaling. The seventh (e.g., the fourth message of a second procedure) message may include action(s) related to measurement (e.g., enabling/disabling a measurement/measurement report triggering event, adjusting measurement report triggering event parameters such as a threshold, TTT, hysteresis, offset) and/or configuration(s) for AI/ML functionality (e.g., model parameters). The seventh (e.g., the fourth message of a second procedure) message may imply functionality/model selection, activation, deactivation, switching, and/or fallback operation of an AI/ML functionality and/or performing actions.

The UE may be configured with a first (measurement) configuration before/upon/after functionality/model selection, activation, deactivation, switching, and/or fallback operation of an AI/ML functionality. The UE may use a second (measurement) configuration for AI/ML functionality. The second (measurement) configuration may be included in the fourth (e.g., the first message of a second procedure) message. The second (measurement) configuration may be a separate configuration or an extension to the first (measurement) configuration. The second (measurement) configuration may include measurement object(s), report configuration(s), measurement identity/identities. The second (measurement) configuration may include modifications/adjustments to the first (measurement) configuration. The modifications/adjustments may include a subset of beams to measure/skip, the time to measure/skip, the frequency to measure/skip, offset or scaling factors to a threshold, hysteresis, TTT, offset for measurement report triggering event.

A measurement object in the second (measurement) configuration may be associated with a measurement object in the first (measurement) configuration. A report configuration in the second (measurement) configuration may be associated with a report configuration in the first (measurement) configuration. A measurement identity in the second (measurement) configuration may be associated with a measurement identity in the first (measurement) configuration. A modification/adjustment may be associated with a measurement object, a report configuration, a measurement identity. The association may be indicated by using the same ID(s), extra ID(s)/index(indices)/parameter(s), and/or specified in the specification. The association may be a one-to-one, one-to-many, many-to-one mapping.

When the condition(s) and/or threshold(s) to evaluate an action related to measurement included in the fourth message (e.g., the first message of a second procedure) is met, the UE may use/apply the second (measurement) configuration. The second (measurement) configuration may be applied partially (i.e., only apply the configurations associated with the action whose condition(s) and/or threshold(s) are fulfilled).

When the condition(s) and/or threshold(s) to evaluate an action related to measurement included in the fourth message (e.g., the first message of a second procedure) is met, the UE may ignore/revert the first (measurement) configuration. The first (measurement) configuration may be ignored/reverted partially (i.e., only ignore the configurations associated with the action whose condition(s) and/or threshold(s) are fulfilled).

More details of the second procedure are described below. One or more features in different examples may be combined as another example, in whole or in part.

The UE may, based on the conditions to evaluate included in the fourth message (e.g., the first message of a second procedure), decide whether to perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event). The conditions may include at least one of: location, distance to a serving cell, moving speed, serving/current beam(s), quality of cell, quality of serving/current beam(s), likelihood of handover/RLF/beam failure/measurement event, model performance, and/or etc.

### Location

The NW may provide an indication to the location and/or provide an inquiry of location to the UE. The UE may perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event) when/if (at least)/in response to the UE location meeting the provided indication and/or inquiry.

### Distance to a Serving Cell

The NW may configure threshold(s) for the distance to serving cell(s) for the UE. The UE may perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event) when/if (at least)/in response to the UE distance to the serving cell(s) is above or below the threshold(s).

### Moving Speed

The NW may configure threshold(s) for moving speed of the UE. The UE may perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event) when/if (at least)/in response to the UE moving speed is above or below the threshold(s).

### Serving/Current Beam(s)

The NW may provide an indication to beam(s)/cell(s) to the UE. The UE may perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event) when the indicated beam(s)/cell(s) is the current/serving beam(s)/cell(s) or when/if (at least)/in response to the indicated beam(s)/cell(s) is measured by the UE and/or configured to the UE.

### Quality of Cell

The NW may configure threshold(s) for the quality of cell(s) for the UE. The UE may activate (or deactivate) a function, enable (or disable) a measurement, enable (or disable) a measurement report triggering event, and/or adjust a parameter (e.g., for a measurement report triggering event) when/if (at least)/in response to the quality of the cell(s) is above or below the threshold(s).

### Quality of Serving/Current Beam(s)

The NW may configure threshold(s) for the quality of beam(s) for the UE. The UE may perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event) when/if (at least)/in response to the quality of the beam(s) is above or below the threshold(s).

### Likelihood of Handover/RLF/Beam Failure/Measurement Event

The NW may configure threshold(s) for the likelihood/probability of handover/RLF/beam failure/measurement event for the UE. The UE may perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event) when/if (at least)/in response to the likelihood of handover/RLF/beam failure/measurement event is above or below the threshold(s).

### Model Performance

The NW may configure threshold(s) for the performance of AI/ML model(s) for the UE. The UE may perform functionality/model selection, activation, deactivation, switching, and/or fallback operation, activate (or deactivate) a function, enable (or disable) a measurement, enable (or disable) a measurement report triggering event, and/or adjust a parameter (e.g., for a measurement report triggering event) when/if (at least)/in response to the performance of AI/ML model(s) is above or below the threshold(s).

The UE may, based on the (additional) information to report indicated/configured in the fourth message (e.g., the first message of a second procedure), report the (additional) information to the NW. The report may be through UAI or through a response message such as RRCReconfigurationComplete. The (additional) information may include at least one of: location, distance to a serving cell, moving speed, serving/current beam(s), quality of cell, quality of serving/current beam(s), likelihood of handover/RLF/beam failure/measurement event, model performance, and/or etc.

### Location

The NW may provide an indication to the location and/or provide an inquiry of location to the UE. The UE may report an indication of the location or response to the inquiry of location to the NW.

### Distance to Serving Cell

The NW may configure the serving cell(s) for the UE to report the distance. The UE may report the distance to the serving cell(s) to the NW.

### Moving Speed

The NW may configure the UE to report its moving speed. The UE may report its moving speed to the NW.

### Serving/Current Beam(s)

The NW may provide an indication to beam(s)/cell(s) to the UE. The UE may report an indication of beam(s)/cell(s) to the UE to the NW.

### Quality of Cell

The NW may configure the cell(s) for the UE to report the quality. The UE may report the quality of cell(s) to the NW.

### Quality of Serving/Current Beam(s)

The NW may configure the beam(s) for the UE to report the quality. The UE may report the quality of beam(s) to the NW.

### Likelihood of Handover/RLF/Beam Failure/Measurement Event

The NW may configure the UE to report its likelihood/probability of handover/RLF/beam failure/measurement event. The UE may report its likelihood/probability of handover/RLF/beam failure/measurement event to the NW.

### Model Performance

The NW may configure the UE to report the performance of AI/ML model(s). The UE may report the performance of AI/ML model(s) to the NW.

Several examples of the operation of AI/ML assisted mobility are described below. The operation may comprise the first procedure (e.g., steps (or messages) 1 to 3 may be the first procedure). The operation may comprise the second procedure (e.g., steps (or messages) 4 to 7 may be the second procedure). Not every step in an example may be necessary. One or more steps in an example may be omitted (or optional) as another example. Not every step in an example needs to be performed in sequential order. One or more steps in an example may be exchanged in order as another example. One or more steps in an example may be combined as another example. One or more steps in an example may be combined with one or more steps in another example as yet another example. One or more steps/messages in an example may be combined as one step/message. A first procedure may be combined with a second procedure as another example.

In one example, the operation may comprise one or more of the following steps:
The UE may receive a first message from the NW. The message may include conditions to evaluate applicable functionalities.
The UE may transmit a second message to the NW. The message may indicate the applicable functionalities after the UE evaluates the conditions in the first message.
The UE may transmit a third message indicating the updated applicable functionalities if required.
The UE may receive a fourth message from the NW. The message may include configurations for an AI/ML functionality and/or actions to a measurement configuration. The message may include conditions to perform operations (e.g., activation, deactivation) to the AI/ML functionality and/or perform actions to measurement configuration(s).
The UE may perform operations (e.g., activation, deactivation) to AI/ML functionality and/or perform actions to a measurement configuration based on the conditions in the fourth message.
The UE may transmit a fifth message to the NW. The message may include the status of the configured AI/ML functionality (e.g., activation status).
The UE may transmit a sixth message to the NW including the updated status of the configured AI/ML functionality if required.

In another example, the operation may comprise one or more of the following steps:
The UE may receive a first message from the NW. The message may include conditions to evaluate applicable functionalities.
The UE may transmit a second message to the NW. The message may indicate the applicable functionalities after UE evaluates the conditions in the first message.
The UE may transmit a third message indicating the updated applicable functionalities if required.
The UE may receive a fourth message from the NW. The message may include configurations for an AI/ML functionality and/or actions to a measurement configuration. The message may also indicate (additional) information for the UE to report.
The UE may transmit a fifth message to the NW. The message may include (additional) information to report based on the indication in the fourth message.
The UE may transmit a sixth message to the NW including the updated (additional) information if required.
The UE may receive a seventh message from the NW. The message may indicate an operation (e.g., activation, deactivation) to the AI/ML functionality and/or perform actions to measurement configuration(s). The message may include configurations for an AI/ML functionality and/or actions to a measurement configuration if not received in the fourth message.

In another example, the operation may comprise one or more of the following steps:
The UE may receive a first message from the NW. The message may indicate (additional) information to report.
The UE may transmit a second message to the NW. The message may include (additional) information to report based on the indication in the first message.
The UE may transmit a third message including the updated (additional) information if required.
The UE may receive a fourth message from the NW. The message may include configurations for an AI/ML functionality and/or actions to a measurement configuration. The message may include conditions to perform operations (e.g., activation, deactivation) to the AI/ML functionality and/or perform actions to measurement configuration(s).
The UE may perform operations (e.g., activation, deactivation) to AI/ML functionality and/or perform actions to a measurement configuration based on the conditions in the fourth message.
The UE may transmit a fifth message to the NW. The message may include the status of the configured AI/ML functionality (e.g., activation status).
The UE may transmit a sixth message to the NW including the updated status of the configured AI/ML functionality if required.

In another example, the operation may comprise one or more of the following steps:
The UE may receive a first message from the NW. The message may indicate (additional) information to report.
The UE may transmit a second message to the NW. The message may include (additional) information to report based on the indication in the first message.
The UE may transmit a third message including the updated (additional) information if required.
The UE may receive a fourth message from the NW. The message may include configurations for an AI/ML functionality and/or actions to a measurement configuration. The message may also indicate (additional) information for the UE to report.
The UE may transmit a fifth message to the NW. The message may include (additional) information to report based on the indication in the fourth message.
The UE may transmit a sixth message to the NW including the updated (additional) information if required.
The UE may receive a seventh message from the NW. The message may indicate an operation (e.g., activation, deactivation) to the AI/ML functionality and/or perform actions to measurement configuration(s). The message may include configurations for an AI/ML functionality and/or actions to a measurement configuration if not received in the fourth message.

In another example, the operation may comprise one or more of the following steps:
The UE may receive a first message from the NW. The message may include conditions to evaluate applicable functionalities. The message may indicate (additional) information to report.
The UE may transmit a second message to the NW. The message may indicate the applicable functionalities after the UE evaluates the conditions in the first message. The message may include (additional) information to report based on the indication in the first message.
The UE may transmit a third message indicating the updated applicable functionalities and/or updated (additional) information if required.
The UE may receive a fourth message from the NW. The message may include configurations for an AI/ML functionality and/or actions to a measurement configuration. The message may include conditions to perform operations (e.g., activation, deactivation) to the AI/ML functionality and/or perform actions to measurement configuration(s).
The UE may perform operations (e.g., activation, deactivation) to AI/ML functionality and/or perform actions to a measurement configuration based on the conditions in the fourth message.
The UE may transmit a fifth message to the NW. The message may include the status of the configured AI/ML functionality (e.g., activation status).
The UE may transmit a sixth message to the NW including the updated status of the configured AI/ML functionality if required.

In another example, the operation may comprise one or more of the following steps:
The UE may receive a first message from the NW. The message may include conditions to evaluate applicable functionalities. The message may indicate (additional) information to report.
The UE may transmit a second message to the NW. The message may indicate the applicable functionalities after the UE evaluates the conditions in the first message. The message may include (additional) information to report based on the indication in the first message.
The UE may transmit a third message indicating the updated applicable functionalities and/or updated (additional) information if required.
The UE may receive a fourth message from the NW. The message may include configurations for an AI/ML functionality and/or actions to a measurement configuration. The message may also indicate (additional) information for the UE to report.
The UE may transmit a fifth message to the NW. The message may include (additional) information to report based on the indication in the fourth message.
The UE may transmit a sixth message to the NW including the updated (additional) information if required.
The UE may receive a seventh message from the NW. The message may indicate an operation (e.g., activation, deactivation) to the AI/ML functionality and/or perform actions to measurement configuration(s). The message may include configurations for an AI/ML functionality and/or actions to a measurement configuration if not received in the fourth message.

In another example, the operation may comprise one or more of the following steps:
The UE may receive a first message from the NW. The message may include conditions to evaluate applicable functionalities. The message may include configurations for an AI/ML functionality and/or actions to a measurement configuration. The message may include conditions to perform operations (e.g., activation, deactivation) to the AI/ML functionality and/or perform actions to measurement configuration(s).
The UE may transmit a second message to the NW. The message may indicate the applicable functionalities after UE evaluates the conditions in the first message. The UE may perform operations (e.g., activation, deactivation) to AI/ML functionality and/or perform actions to a measurement configuration based on the conditions in the first message. The message may include the status of the configured AI/ML functionality (e.g., activation status).
The UE may transmit a third message indicating the updated applicable functionalities/status of the configured AI/ML functionality if required.

In another example, the operation may comprise one or more of the following steps:
The UE may receive a first message from the NW. The message may indicate (additional) information to report. The message may include configurations for an AI/ML functionality and/or actions to a measurement configuration.
The UE may transmit a second message to the NW. The message may include (additional) information to report based on the indication in the first message.
The UE may transmit a third message including the updated (additional) information if required.
The UE may receive a fourth message and/or a seventh message from the NW. The message may indicate an operation (e.g., activation, deactivation) to the AI/ML functionality and/or perform actions to measurement configuration(s). The message may include configurations for an AI/ML functionality and/or actions to a measurement configuration if not received in the first/fourth message.

In another example, the operation may comprise one or more of the following steps:
The UE may receive a first message from NW. The message may include conditions to evaluate applicable functionalities. The message may indicate (additional) information to report. The message may include configurations for an AI/ML functionality and/or actions to a measurement configuration.
The UE may transmit a second message to the NW. The message may indicate the applicable functionalities after the UE evaluates the conditions in the first message. The message may include (additional) information to report based on the indication in the first message.
The UE may transmit a third message including the updated applicable functionalities and/or updated (additional) information if required.
The UE may receive a fourth message and/or a seventh message from the NW. The message may indicate an operation (e.g., activation, deactivation) to the AI/ML functionality and/or perform actions to measurement configuration(s). The message may include configurations for an AI/ML functionality and/or actions to a measurement configuration if not received in the first/fourth message.

For example, the UE may be configured with a configuration for a measurement report triggering event. The configuration may indicate or include more than one values of a first parameter for the measurement report triggering event. The first parameter may be a threshold, TTT, hysteresis, or offset. The first parameter may be used to determine whether the measurement report triggering event is fulfilled and/or to triggering a measurement report transmission associated with the measurement report triggering event. The configuration may indicate or include a second parameter (associated with the condition(s) mentioned above) (e.g., threshold and/or (reference) location) for the measurement report triggering event. The UE may select (by the UE itself) a value from the more than one values of the first parameter to be used to determine whether the measurement report triggering event is fulfilled. The UE may select (by the UE itself) a value from the more than one value of the first parameter based on the second parameter and/or the condition(s) mentioned above. The UE may determine (by the UE itself) whether to enable or disable the measurement report triggering event. The UE may determine whether to enable or disable the measurement report triggering event based on the second parameter and/or the condition(s) mentioned above. Enabling or disabling the measurement report triggering event may mean to estimate or not to estimate the measurement report triggering event being fulfilled or not. The UE may determine (by the UE itself) whether to perform measurement (on a measurement object(s)) associated with the measurement report triggering event. The UE may determine whether to perform measurement (on a measurement object(s)) associated with the measurement report triggering event based on the second parameter and/or the condition(s) mentioned above.

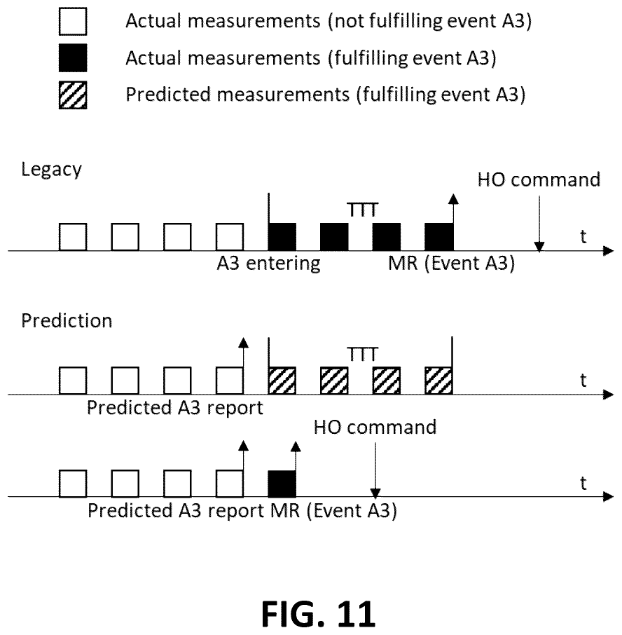

FIG. 11 describes one example of the invention. Based on an event configured by a network, wherein the conditions for the event includes at least the quality of at least one cell from the measurement prediction, the UE reports the outcome (e.g., measurement result) of the event to the network; and the UE performs at least one action: (1) enabling a measurement report triggering event; (2) adjusting a value for a parameter (e.g., TTT) of a measurement report event adjust measurement, or selecting a value of more than one value for the parameter (e.g., TTT) of the measurement report event, wherein the more than one value is configured by the network.

Various examples and embodiments of the present invention are described below. For the methods, alternatives, concepts, examples, and embodiments detailed above and herein, the following aspects and embodiments are possible.

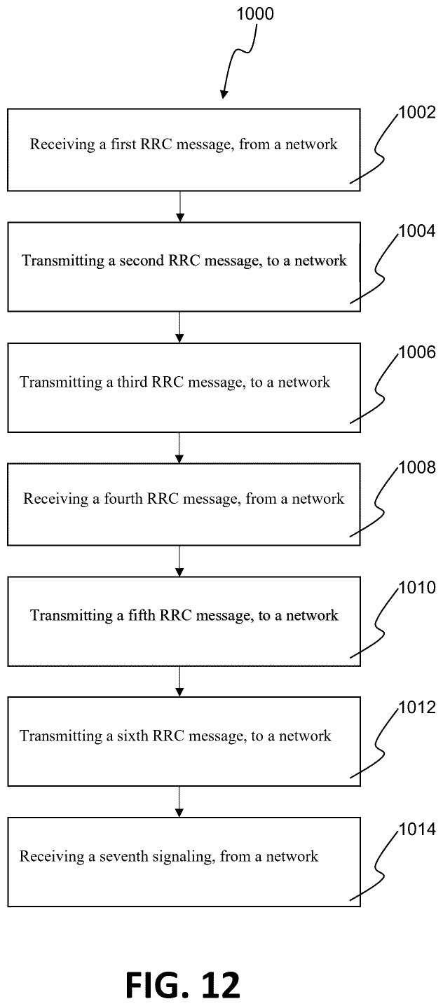

Referring to FIG. 12, with this and other concepts, systems, and methods of the present invention, a method 1000 for a first UE in a wireless communication system comprises receiving a first RRC message, from a network (step 1002), transmitting a second RRC message, to a network (step 1004), transmitting a third RRC message, to a network (step 1006), receiving a fourth RRC message, from a network (step 1008), transmitting a fifth RRC message, to a network (step 1010), transmitting a sixth RRC message, to a network (step 1012), and receiving a seventh signaling, from a network (1014).

In various embodiments, the first RRC message received includes condition(s) to evaluate, triggering condition(s), and configuration(s) to perform transmission/reporting.

In various embodiments, the second RRC message transmitted indicates the applicable functionalities based on the conditions to evaluate in the first message.

In various embodiments, if the condition(s) have changed, or according to the triggering condition(s) and configuration(s) to perform transmission/reporting, the UE transmits a third RRC message with the updated applicable functionalit(ies).

In various embodiments, the fourth RRC message received includes configuration(s) for AI/ML functionality.

In various embodiments, the fourth RRC message received includes (additional) information to report, triggering condition(s), and configuration(s) to perform transmission/reporting.

In various embodiments, the fifth RRC message transmitted includes the (additional) information requested by a network.

In various embodiments, if the (additional) information have changed, or according to the report triggering condition(s) and configuration(s), the UE transmits a sixth RRC message with the updated information.

In various embodiments, the seventh signaling received indicates at least one of the following operations: functionality/model selection, activation, deactivation, switching, and/or fallback operation.

In various embodiments, when AI/ML functionality is activated, the first UE uses/applies the AI/ML configuration from the fourth RRC message.

Referring back to FIGS. 3 and 4, in one or more embodiments from the perspective of a first UE in a wireless communication system, the device 300 includes a program code 312 stored in memory 310 of the transmitter. The CPU 308 could execute program code 312 to: (i) receive a first RRC message, from a network; (ii) transmit a second RRC message, to a network; (iii) transmit a third RRC message, to a network; (iv) receive a fourth RRC message, from a network; (v) transmit a fifth RRC message, to a network; (vi) transmit a sixth RRC message, to a network; and (vii) receive a seventh signaling, from a network. Moreover, the CPU 308 can execute the program code 312 to perform all of the described actions, steps, and methods described above, below, or otherwise herein.

When the AI/ML functionality is not activated (e.g., before the AI/ML functionality is activated), the NW may provide a measurement configuration without AI/ML functionality. And the UE performs the measurement (e.g., RRM measurement) based on the measurement configuration (without AI/ML functionality). When the NW would like to activate AI/ML functionality, a configuration for an AI/ML functionality may be provided to the UE to perform inference. And the NW may reconfigure the measurement configuration, with the consideration of AI/ML functionality. When AI/ML functionality is performed/activated, the UE performs the measurement based on the NW configuration for AI/ML functionality.

When AI/ML functionality is activated, some problem may happen (e.g., internal issues such as memory and/or power issues), resulting in that AI/ML functionality cannot continue. The UE may stop performing AI/ML functionality when the problem occurs, which may lead to degradation in handover performance.

For example, the problem may occur in a (bad) radio condition where a measurement report triggering event could trigger. The problem may cause the UE to not perform measurement reporting and subsequently miss a chance to perform handover.

For another example, when the UE is performing AI/ML functionality (and/or measurement prediction), the UE may not require measurement gap. And when the UE stops AI/ML functionality (and/or measurement prediction), the UE may require a measurement gap, e.g., to perform inter-frequency measurement (instead of prediction). However, it is not clear whether/when/how to enable the measurement gap for the UE, e.g., based on the current AI/ML model(s). For example, if the UE autonomously utilizes a measurement gap without NW awareness, data loss may occur.

To at least solve the issues described above, at least some methods described below could be considered. In the following, the “AI/ML functionality” may be or be replaced by an “AI/ML function”, an “AI/ML assisted mobility”, an “AI/ML assisted measurement”, an “AI/ML enhanced mobility”, an “AI/ML enhanced measurement”, an “AI/ML measurement”, a “functionality” or a “function”.

At least some fallback operation/procedure/configuration should be defined (or specified), e.g., to ensure seamless fallback and/or maintain handover performance. Several examples of the fallback operation/procedure/configuration of AI/ML functionality are described below. Not every step in an example may be necessary. One or more steps in an example may be omitted (or optional) as another example. Not every step in an example needs to be performed in sequential order. One or more steps in an example may be exchanged in order as another example. One or more steps in an example may be combined as another example. One or more steps in an example may be combined with one or more steps in another example as another example. One or more steps/messages in an example may be combined as one step/message.

When (or in response to) some problem occurs (e.g., resulting in that AI/ML functionality cannot continue), the UE may initiate a fallback procedure (or perform a fallback operation). The fallback operation (or procedure) may comprise at least one or more of the following actions. The UE may perform one or more of the following actions during/in the fallback operation (or procedure):
Stop performing AI/ML functionality (e.g., measurement prediction).
Stop performing measurement based on the measurement configuration with AI/ML functionality (e.g., measurement prediction).
Switch to a fallback configuration (e.g., measurement configuration); the fallback configuration may be configured to the UE beforehand; the fallback configuration may include no AI/ML functionality.
Trigger (or transmit) a report (or indication) to the NW (e.g., to indicate the fallback, through UAI and/or updated applicable functionalities).

The fallback procedure (or operation) initiated by the UE may autonomously switch to a fallback configuration. An example is shown below:
The UE stops performing AI/ML functionality.
The UE switches to a (previously configured) fallback configuration.
The UE reports the fallback to the NW (e.g., through UAI and/or updated applicable functionalities).
The NW responds to the UE fallback (e.g., reconfigure/disable/deactivate AI/ML functionality, retransmit missing data).

Alternatively and/or additionally in certain embodiments, the fallback procedure (or operation) initiated by the UE may not autonomously switch to a fallback configuration. An example is shown below:
The UE stops performing AI/ML functionality.
The UE reports the fallback to NW.
The NW may disable/deactivate the AI/ML functionality and/or indicate a fallback configuration to use (e.g., through L3/L2/L1 signaling).

Other examples may be formed by adding or removing one or more of the actions specified above, in whole or in part.

The UE may be configured with a first (measurement) configuration, e.g., before/upon/after functionality/model selection, activation, deactivation, switching, and/or fallback operation of an AI/ML functionality. The first (measurement) configuration may include no AI/ML functionality. The first (measurement) configuration may not be associated with AI/ML functionality. The first (measurement) configuration may be a legacy configuration/measurement. The first (measurement) configuration may include a configuration of a measurement gap.

The UE may be configured with a second (measurement) configuration for AI/ML functionality. The second (measurement) configuration may include AI/ML functionality. The second (measurement) configuration may be associated with AI/ML functionality. The second (measurement) configuration may not be a legacy configuration. The second (measurement) configuration may be a separate configuration or an extension to the first (measurement) configuration. The second (measurement) configuration may include measurement object(s), report configuration(s), measurement identity(identities). The second (measurement) configuration may not include a configuration of a measurement gap.

The second (measurement) configuration may include modifications/adjustments to the first (measurement) configuration. The modifications/adjustments may include a subset of beams to measure/skip, the time to measure/skip, the frequency to measure/skip, offset or scaling factors to a threshold, hysteresis, TTT, offset for measurement report triggering event. The NW may reconfigure the measurement configuration of the UE by replacing the first (measurement) configuration with the second (measurement) configuration.

The second (measurement) configuration may indicate more measurement occasions than the first (measurement) configuration.

Upon (or in response to) receiving a reconfiguration message (e.g., including the second configuration), the UE may stop performing measurement based on the first configuration, and/or start performing measurement based on the second configuration.

In one or more examples, the UE may receive a first (measurement) configuration. The UE may not apply the first (measurement) configuration, e.g., in response to receiving the first (measurement) configuration. The UE may store the first (measurement) configuration, e.g., in response to receiving the first (measurement) configuration. The UE may receive a second (measurement) configuration. The UE may apply the second (measurement) configuration, e.g., in response to receiving the second (measurement) configuration. The first (measurement) configuration and the second (measurement) configuration may be included in the same message, e.g., RRC reconfiguration message. The first (measurement) configuration and the second (measurement) configuration may be included in different messages, e.g., RRC reconfiguration messages. The UE may perform/start/enable/activate AI/ML functionality and/or measurement, e.g., based on the second (measurement) configuration. The UE may initiate a fallback procedure (or perform at least a fallback operation) when (or in response to) some problem occurs (and/or the AI/ML functionality cannot continue). The UE may stop the AI/ML functionality and/or measurement, e.g., based on the second (measurement) configuration, as a fallback operation, and/or during the fallback procedure. The UE may apply a fallback configuration, e.g., the second (measurement) configuration, as a fallback operation, and/or during the fallback procedure. The UE may trigger or transmit a report (or indication) to the NW, e.g., indicating the fallback, as a fallback operation, and/or during the fallback procedure.

A measurement object in the second (measurement) configuration may be associated with a measurement object in the first measurement configuration. A report configuration in the second (measurement) configuration may be associated with a report configuration in the first measurement configuration. A measurement identity in the second (measurement) configuration may be associated with a measurement identity in the first measurement configuration. A modification/adjustment may be associated with a measurement object, a report configuration, a measurement identity. The association may be indicated by using the same ID(s), extra ID(s)/index(indices)/parameter(s), and/or specified in the specification. The association may be a one-to-one, one-to-many, many-to-one mapping.

The UE may use/apply the second (measurement) configuration when the AI/ML functionality is activated. The second (measurement) configuration may be applied partially (i.e., only apply the configurations associated with the activated functionality).

The UE may ignore/revert the first measurement configuration when the AI/ML functionality is deactivated/fallbacked. The first measurement configuration may be ignored/reverted partially (i.e., only apply the configurations associated with the deactivated/fallbacked functionality).

A fallback procedure (or operation) may comprise one or more of the actions described below, e.g., embodiments for performing fallback (when to perform fallback, what is the action of fallback).

The UE may stop performing AI/ML functionality based on (or according to) the AI/ML configuration when (or in response to) the UE identifies some problem and/or is not capable of performing (or continuing) AI/ML functionality. The problem may originate from physical issues of a device (e.g., memory, power, runtime error, and/or scheduling), performance of an AI/ML model (e.g., the UE monitors the performance and a model is determined not suitable), and/or conditions to evaluate for applicability (e.g., the UE determines a functionality is no longer applicable). The problem may be prediction (or inference result) is not available at a specified time instance, before a report timing and/or before a measurement timing. The problem may be the UE cannot produce a prediction (or inference result) at a specified time instance, before a report timing and/or before a measurement timing. The problem may be the UE can no longer produce a prediction (or inference result). The problem may be the UE (currently) have no resources (e.g., memory, power, computation resources) to perform a prediction, inference, and/or AI/ML related operations.

The UE may switch to a legacy measurement (e.g., measurement without AI/ML functionality). The UE may ignore/revert the use/appliance of the second (measurement) configuration for AI/ML functionality.

The UE may use/apply the first (measurement) configuration. The legacy measurement may be the first (measurement) configuration described above. The legacy measurement may be a measurement method without AI/ML assistance at the UE-side and/or the NW-side. The legacy measurement may be a measurement method without an AI/ML model participating at the UE-side and/or the NW-side. The legacy measurement may be a measurement method without AI/ML functionality activated/configured/supported/applicable at UE—the side and/or NW-side. The legacy measurement may be a measurement method in NR/Long-Term Evolution (LTE) and/or other releases of 3GPP. The legacy measurement may be a fallback configuration (for measurement). The legacy measurement may be a measurement configuration.

For example, the UE may measure measurement object(s) from the first measurement configuration, which may be associated with one or more measurement object(s) from the second (measurement) configuration for AI/ML functionality.

For example, the UE may use measurement report triggering event(s) from the first measurement configuration, which may be associated with one or more measurement report triggering event(s) from the second (measurement) configuration for AI/ML functionality.

For example, the UE may use measurement identity(identities) from the first measurement configuration, which may be associated with one or more measurement identities from the second (measurement) configuration for AI/ML functionality.

For example, the UE may not measure measurement object(s) from the second (measurement) configuration for AI/ML functionality, which may be associated with one or more measurement object(s) from the first measurement configuration.

For example, the UE may not use measurement report triggering event(s) from the second (measurement) configuration for AI/ML functionality, which may be associated with one or more measurement report triggering event(s) from the first measurement configuration.

For example, the UE may not use measurement identity(identities) from the second (measurement) configuration for AI/ML functionality, which may be associated with one or more measurement identities from the first measurement configuration.

For example, the UE may revert the modification(s)/adjustment(s) made to the measure measurement object(s) from the first measurement configuration.

For example, the UE may revert the modification(s)/adjustment(s) made to the measurement report triggering event(s) from the first measurement configuration.

For example, the UE may revert the modification(s)/adjustment(s) made to the measurement identity(identities) from the first measurement configuration.

The UE may trigger (or transmit) a report (or indication) to the NW. The UE may indicate to the NW that it is currently not able to perform AI/ML functionality. This may be through explicit signaling (e.g., L3/L2/L1 signaling) or an update to applicable functionalities (e.g., UAI, response to RRC message such as RRCReconfigurationComplete). The timing may be the same/different with the timing of when (or in response to) the UE identifies some problem and/or is not capable of performing (or continuing) AI/ML functionality.

The timing may be same/different with the timing to switch to a (legacy) measurement (e.g., measurement without AI/ML functionality). The timing may be before/after the timing to switch to a (legacy) measurement (e.g., measurement without AI/ML functionality).

More details of the fallback procedure (or operation) are described below. One or more features in different examples may be combined as another example, in whole or in part.

The UE may stop the AI/ML functionality and/or switch to a (legacy) measurement (e.g., measurement without AI/ML functionality) during (or upon) fallback procedure (or operation) autonomously. The (legacy) measurement (e.g., measurement without AI/ML functionality) may be previously configured. The UE may report to the NW about the fallback, e.g., through an update to applicable functionalities indicating a functionality is no longer applicable and/or explicit L3/L2/L1 signaling. The NW may reconfigure/signal UE in response to the message (e.g., to disable/deactivate AI/ML functionality).

When the UE is not capable of following the AI/ML configuration and/or perform AI/ML functionality, this may cause the UE and the NW to not align with the behavior/configuration. For example, the NW may think the UE is performing AI/ML functionality on cell(s)/beam(s) and expect to receive report(s) about the cell(s)/beam(s).

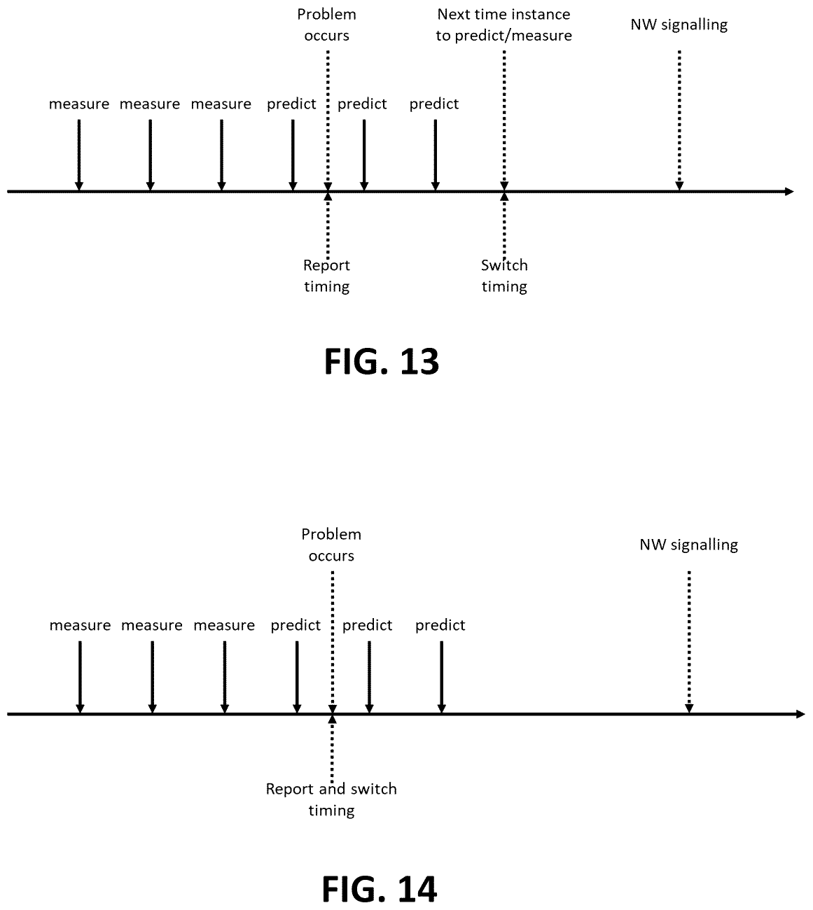

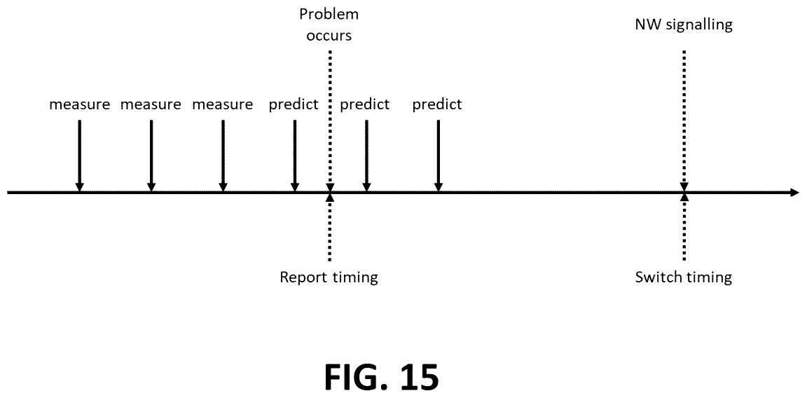

The UE may not switch to a (legacy) measurement (e.g., measurement without AI/ML functionality) immediately after some problem occurs and the UE stops performing AI/ML functionality, e.g., if (at least) the UE has previously predicted measurements for future and/or current time instances. An example is shown in FIG. 13. The UE may perform a fallback procedure (e.g., stop performing AI/ML functionality and/or report fallback to the NW) without switching to a (legacy) measurement (e.g., measurement without AI/ML functionality) if (at least) the UE has previously predicted measurements for future and/or current time instances. The UE may switch to a (legacy) measurement (e.g., measurement without AI/ML functionality) at least when there is no more predicted measurements for future and/or current time instances. The UE may switch to a (legacy) measurement (e.g., measurement without AI/ML functionality) after reporting a fallback to the NW but no more predicted measurements for future and/or current time instances. The UE may switch to a (legacy) measurement (e.g., measurement without AI/ML functionality) immediately after some problem occurs and/or the UE stops performing AI/ML functionality. An example is shown in FIG. 14. FIG. 15 provides another example of report and switching timing after some problem occurs, in accordance with embodiments of the present invention.

Alternatively and/or additionally in certain embodiments, the UE may stop the AI/ML functionality and/or not switch to a (legacy) measurement (e.g., measurement without AI/ML functionality) during (or upon) the fallback procedure (or operation) autonomously. The UE may report to the NW about the fallback, e.g., through an update to applicable functionalities indicating a functionality is no longer applicable and/or explicit L3/L2/L1 signaling.

The NW may reconfigure/signal the UE (e.g., L3/L2/L1 signaling) in response to the message (e.g., to disable/deactivate AI/ML functionality). The signaling from the NW may indicate the disable/deactivate of AI/ML functionality. The signaling from the NW may indicate a switch to a (legacy) measurement (e.g., measurement without AI/ML functionality). The signaling may or may not remove the configuration for AI/ML functionality. The (legacy) measurement (e.g., measurement without AI/ML functionality) may be previously configured. The NW may indicate the association between measurement object(s), report configuration(s), and/or measurement identity(identities) from the first (measurement) configuration and the second (measurement) configuration. The signaling from the NW may include ID(s), index(indices), parameter(s) to indicate the association.

Various examples and embodiments of the present invention are described below. For the methods, alternatives, concepts, examples, and embodiments detailed above and herein, the following aspects and embodiments are possible.

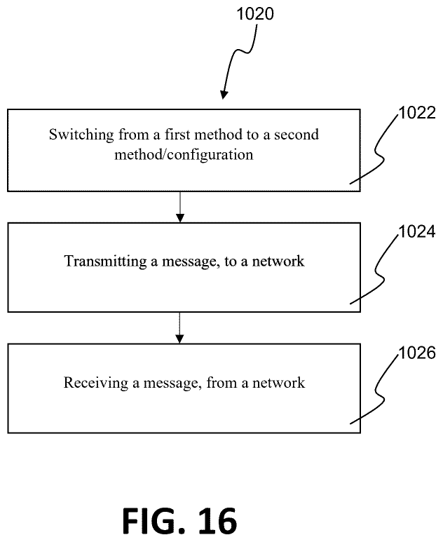

Referring to FIG. 16, with this and other concepts, systems, and methods of the present invention, a method 1020 for a UE in a wireless communication system comprises switching from a first method to a second method/configuration (step 1022), transmitting a message, to a network (step 1024), and receiving a message, from a network (step 1026).

In various embodiments, the UE is capable of AI/ML assisted measurement.

In various embodiments, the first method is an AI/ML assisted measurement method.

In various embodiments, the second method is a legacy measurement method.

In various embodiments, the configuration of the first method includes measurement object(s).

In various embodiments, the configuration of the first method includes report configuration(s).

In various embodiments, the configuration of the first method includes measurement identity(identities).

In various embodiments, the configuration of the first method includes association to measurement object(s) in the configuration of the second method.

In various embodiments, the configuration of the first method includes association to report configuration(s) in the configuration of the second method.

In various embodiments, the configuration of the first method includes association to measurement identity(identities) in the configuration of the second method.

In various embodiments, the switching is autonomous.

In various embodiments, the transmitted message indicates the UE is currently not able to perform the first method.

In various embodiments, the transmitted message is an L3 signaling or L2 signaling or L1 signaling.

In various embodiments, the received message indicates the disabling of the first method.

In various embodiments, the received message is an L3 signaling or L2 signaling or L1 signaling.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) switch from a first method to a second method/configuration; (ii) transmit a message, to a network; and (iii) receive a message, from a network. Moreover, the CPU 308 can execute the program code 312 to perform all of the described actions, steps, and methods described above, below, or otherwise herein.

Various examples and embodiments of the present invention are described below. For the methods, alternatives, concepts, examples, and embodiments detailed above and herein, the following aspects and embodiments are possible.

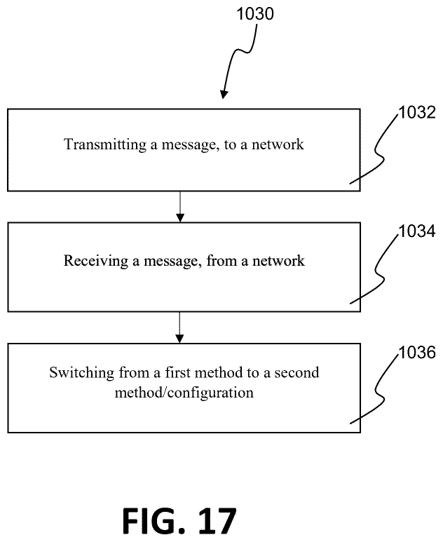

Referring to FIG. 17, with this and other concepts, systems, and methods of the present invention, a method 1030 for a UE in a wireless communication system comprises transmitting a message, to a network (step 1032), receiving a message, from a network (step 1034), and switching from a first method to a second method/configuration (step 1036).

In various embodiments, the UE is capable of AI/ML assisted measurement.

In various embodiments, the first method is an AI/ML assisted measurement method.

In various embodiments, the second method is a legacy measurement method.

In various embodiments, the configuration of the first method includes measurement object(s).

In various embodiments, the configuration of the first method includes report configuration(s).

In various embodiments, the configuration of the first method includes measurement identity(identities).

In various embodiments, the configuration of the first method includes association to measurement object(s) in the configuration of the second method.

In various embodiments, the configuration of the first method includes association to report configuration(s) in the configuration of the second method.

In various embodiments, the configuration of the first method includes association to measurement identity(identities) in the configuration of the second method.

In various embodiments, the switching is autonomous.

In various embodiments, the transmitted message indicates the UE is currently not able to perform the first method.

In various embodiments, the transmitted message is an L3 signaling or L2 signaling or L1 signaling.

In various embodiments, the received message indicates the disabling of the first method.

In various embodiments, the received message indicates a switch to the second method.

In various embodiments, the received message includes association to measurement object(s) in the configuration of the second method.

In various embodiments, the received message includes association to report configuration(s) in the configuration of the second method.

In various embodiments, the received message includes association to measurement identity(identities) in the configuration of the second method.

In various embodiments, the received message is an L3 signaling or L2 signaling or L1 signaling.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) transmit a message, to a network; (ii) receive a message, from a network; and (iii) switch from a first method to a second method/configuration. Moreover, the CPU 308 can execute the program code 312 to perform all of the described actions, steps, and methods described above, below, or otherwise herein.

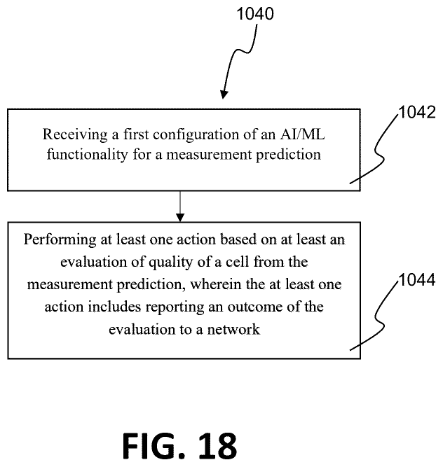

Referring to FIG. 18, with this and other concepts, systems, and methods of the present invention, a method 1040 for a UE in a wireless communication system comprises receiving a first configuration of an AI/ML functionality for a measurement prediction (step 1042), and performing at least one action based on at least an evaluation of quality of a cell from the measurement prediction, wherein the at least one action includes reporting an outcome of the evaluation to a network (step 1044).

In various embodiments, the at least one action includes starting or stopping an estimation of a measurement report event being fulfilled or not, enabling or disabling the measurement report event, using or not using a configuration for measurement reporting, or ignoring at least some of the configuration for measurement reporting.

In various embodiments, the measurement report event or the measurement reporting is based on an actual measurement.

In various embodiments, the at least one action includes reporting, to the network, a measurement report event being enabled or disabled, a configuration for measurement reporting being used or not used, or at least some of the configuration for measurement reporting being ignored.

In various embodiments, the at least one action includes ignoring at least some of the first configuration.

In various embodiments, the at least one action includes adjusting a value for a parameter of a measurement report event, selecting a value of more than one value for the parameter of the measurement report event, or ignoring the parameter of the measurement report event.

In various embodiments, the parameter includes at least one of a threshold, TTT, hysteresis, or offset.

In various embodiments, the outcome of the evaluation includes at least one of quality of at least one cell, location of the UE, moving speed of the UE, quality of at least one beam, performance of the AI/ML functionality, or a probability of handover, the at least one cell is configured by the network, the at least one beam is configured by the network, the quality of the at least one cell is from an actual measurement or the measurement prediction, the quality of the at least one cell is a radio condition or a measurement result of the at least one cell, the quality of the at least one beam is from the actual measurement or the measurement prediction, and/or the quality of the at least one beam is a radio condition or a measurement result of the at least one beam.

In various embodiments, the quality of the cell from the measurement prediction is a radio condition or a measurement result of the cell.

In various embodiments, the method further comprises activating or deactivating the AI/ML functionality based on the quality of the cell, wherein the quality of the cell is from an actual measurement or the measurement prediction, and/or reporting, to the network, the AI/ML functionality being activated or deactivated.

In various embodiments, the method further comprises receiving a second configuration including a threshold for the quality of the cell, wherein the UE performs the at least one action based on at least the evaluation of the quality of the cell from the measurement prediction being above or below the threshold.

Referring back to FIGS. 3 and 4, in one or more embodiments from the perspective of a UE in a wireless communication system, the device 300 includes a program code 312 stored in memory 310 of the transmitter. The CPU 308 could execute program code 312 to: (i) receive a first configuration of an AI/ML functionality for a measurement prediction; and (ii) perform at least one action based on at least an evaluation of quality of a cell from the measurement prediction, wherein the at least one action includes reporting an outcome of the evaluation to a network. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving a first configuration of an Artificial Intelligence/Machine Learning (AI/ML) functionality for a measurement prediction; and
performing at least one action based on at least an evaluation of quality of a cell from the measurement prediction, wherein the at least one action includes reporting an outcome of the evaluation to a network.

2. The method of claim 1, wherein the at least one action includes starting or stopping an estimation of a measurement report event being fulfilled or not, enabling or disabling the measurement report event, using or not using a configuration for measurement reporting, or ignoring at least some of the configuration for measurement reporting.

3. The method of claim 2, wherein the measurement report event or the measurement reporting is based on an actual measurement.

4. The method of claim 1, wherein the at least one action includes reporting, to the network, a measurement report event being enabled or disabled, a configuration for measurement reporting being used or not used, or at least some of the configuration for measurement reporting being ignored.

5. The method of claim 1, wherein the at least one action includes ignoring at least some of the first configuration.

6. The method of claim 1, wherein the at least one action includes adjusting a value for a parameter of a measurement report event, selecting a value of more than one value for the parameter of the measurement report event, or ignoring the parameter of the measurement report event.

7. The method of claim 6, wherein the parameter includes at least one of a threshold, Time-to-Trigger (TTT), hysteresis, or offset.

8. The method of claim 1, wherein:
the outcome of the evaluation includes at least one of quality of at least one cell, location of the UE, moving speed of the UE, quality of at least one beam, performance of the AI/ML functionality, or a probability of handover,
the at least one cell is configured by the network,
the at least one beam is configured by the network,
the quality of the at least one cell is from an actual measurement or the measurement prediction,
the quality of the at least one cell is a radio condition or a measurement result of the at least one cell,
the quality of the at least one beam is from the actual measurement or the measurement prediction,
the quality of the at least one beam is a radio condition or a measurement result of the at least one beam, and/or
the quality of the cell from the measurement prediction is a radio condition or a measurement result of the cell.

9. The method of claim 1, further comprising:
activating or deactivating the AI/ML functionality based on the quality of the cell, wherein the quality of the cell is from an actual measurement or the measurement prediction, and/or
reporting, to the network, the AI/ML functionality being activated or deactivated.

10. The method of claim 1, further comprising receiving a second configuration including a threshold for the quality of the cell, wherein the UE performs the at least one action based on at least the evaluation of the quality of the cell from the measurement prediction being above or below the threshold.

11. A User Equipment (UE), comprising:
a memory; and
a processor operatively coupled with the memory, wherein the processor is configured to execute a program code to:
receive a first configuration of an Artificial Intelligence/Machine Learning (AI/ML) functionality for a measurement prediction; and
perform at least one action based on at least an evaluation of quality of a cell from the measurement prediction, wherein the at least one action includes reporting an outcome of the evaluation to a network.

12. The UE of claim 11, wherein the at least one action includes starting or stopping an estimation of a measurement report event being fulfilled or not, enabling or disabling the measurement report event, using or not using a configuration for measurement reporting, or ignoring at least some of the configuration for measurement reporting.

13. The UE of claim 12, wherein the measurement report event or the measurement reporting is based on an actual measurement.

14. The UE of claim 11, wherein the at least one action includes reporting, to the network, a measurement report event being enabled or disabled, a configuration for measurement reporting being used or not used, or at least some of the configuration for measurement reporting being ignored.

15. The UE of claim 11, wherein the at least one action includes ignoring at least some of the first configuration.

16. The UE of claim 11, wherein the at least one action includes adjusting a value for a parameter of a measurement report event, selecting a value of more than one value for the parameter of the measurement report event, or ignoring the parameter of the measurement report event.

17. The UE of claim 16, wherein the parameter includes at least one of a threshold, Time-to-Trigger (TTT), hysteresis, or offset.

18. The UE of claim 11, wherein:
the outcome of the evaluation includes at least one of quality of at least one cell, location of the UE, moving speed of the UE, quality of at least one beam, performance of the AI/ML functionality, or a probability of handover,
the at least one cell is configured by the network,
the at least one beam is configured by the network,
the quality of the at least one cell is from an actual measurement or the measurement prediction,
the quality of the at least one cell is a radio condition or a measurement result of the at least one cell,
the quality of the at least one beam is from the actual measurement or the measurement prediction,
the quality of the at least one beam is a radio condition or a measurement result of the at least one beam, and/or
the quality of the cell from the measurement prediction is a radio condition or a measurement result of the cell.

19. The UE of claim 11, further comprising:
activating or deactivating the AI/ML functionality based on the quality of the cell, wherein the quality of the cell is from an actual measurement or the measurement prediction, and/or
reporting, to the network, the AI/ML functionality being activated or deactivated.

20. The UE of claim 11, further comprising receiving a second configuration including a threshold for the quality of the cell, wherein the UE performs the at least one action based on at least the evaluation of the quality of the cell from the measurement prediction being above or below the threshold.
